(19) United States
(12) Patent Application Publication
(10) Pub. No.: US 2026/0302779 A1
(43) Pub. Date: Oct. 1, 2026

(54) HYPERFIRM SWARM POWER AND MODULAR LOADS UNDER COMMON CONTROL

(71) Applicant: 1st Avenue Nova, LLC, Los Angeles, CA (US)

(72) Inventor: Thomas BUTTGENBACH, Santa Monica, CA (US)

(73) Assignee: 1st Avenue Nova, LLC, Los Angeles, CA (US)

(21) Appl. No.: 19/631,597

(22) Filed: Mar. 27, 2026

Related U.S. Application Data
(60) Provisional application No. 63/778,754, filed on Mar. 27, 2025.

(51) Int. Cl. H02J 3/0073; H02J 3/00; H02J 3/17; H02J 3/32; H02J 3/38; H02J 7/35; H02J 101/10; H02J 101/24; H02J 101/28; H02J 105/53

(52) U.S. Cl. CPC H02J 3/0073; H02J 3/003; H02J 3/004; H02J 3/17; H02J 3/32; H02J 3/381; H02J 7/35; H02J 2101/10; H02J 2101/25; H02J 2101/28; H02J 2105/53; H02J 2207/20

(57) ABSTRACT

In an embodiment, a system includes a plurality of modular generators. Each modular generator from the plurality of modular generators is configured to produce electrical power. The system further includes a plurality of modular loads. Each modular load from the plurality of modular loads is configured to consume electrical power. The system further includes a connection matrix including a plurality of controllable bridge devices and configured to selectively route electrical power from any one or more modular generators from the plurality of modular generators to any one or more modular loads from the plurality of modular loads. The connection matrix defining, at least in part, a power distribution power.

### CROSS REFERENCE TO RELATED APPLICATION

This application claims priority to U.S. Provisional Patent Application No. 63/778,754, filed Mar. 27, 2025 and titled “HYPERFIRM SWARM POWER AND MODULAR LOADS UNDER COMMON CONTROL,” the contents of which are incorporated by reference herein in their entirety.

### FIELD

One or more embodiments relate to hyperfirm swarm power and modular loads under common control.

### BACKGROUND

Some industrial facilities use large amounts of electrical energy. Such facilities may include data centers (e.g., general purpose data centers or specialized data centers, such as large language model artificial intelligence training data centers), car and truck charging stations, electrolytic hydrogen production plants, water desalination systems, and/or others.

### SUMMARY

In an embodiment, a system includes a plurality of modular generators. Each modular generator from the plurality of modular generators is configured to produce electrical power. The system further includes a plurality of modular loads. Each modular load from the plurality of modular loads is configured to consume electrical power. The system further includes a connection matrix including a plurality of controllable bridge devices and configurable to selectively route electrical power from any one or more modular generators from the plurality of modular generators to any one or more modular loads from the plurality of modular loads. The connection matrix defines, at least in part, a power distribution system. In an example implementation, the connection matrix may be configurable into a first configuration in which at least a subset of electrical power outputs of the plurality of modular generators are merged, and into a second configuration in which a different subset or none of the electrical power outputs of the plurality of modular generators are merged. The system further includes a control system configured to control each of the plurality of modular generators, the plurality of controllable bridge devices of the connection matrix, and the plurality of modular loads.

### BRIEF DESCRIPTION OF THE DRAWINGS

FIG. 1 illustrates delivery of power from an electrical grid to an industrial facility at an HVac delivery point.

FIG. 2 illustrates an industrial facility configured to draw electrical power from a dedicated electricity generating plant.

FIG. 3 illustrates a dedicated electricity generating plant comprising a number of modular generators whose power is aggregated by centralized power aggregation equipment for delivery to a single HVac delivery point.

FIG. 4 illustrates outputs of modular generators kept separate and led to a connecting matrix that enables the generator swarm to be connected to modular loads under common control of a control system, in accordance with some embodiments.

FIG. 5 shows an example system with twelve strings that each include ten solar modules, in accordance with some embodiments.

FIG. 6 illustrates twelve strings of solar modules supplying power to a swarm of three power modules, in accordance with some embodiments.

FIG. 7 shows an example of a set of modular generators that can be connected to modular electrical loads, in accordance with some embodiments.

FIG. 8 illustrates each modular generator connected to an associated modular load, in accordance with some embodiments.

FIG. 9 shows an example of a connecting matrix based on a balancing bus, in accordance with some embodiments.

FIG. 10 illustrates a DC electrical system with an emergency failover system implemented using electrical diodes and a balancing bus arrangement, in accordance with some embodiments.

FIG. 11 illustrates a system with multiple balancing buses, in accordance with some embodiments.

FIG. 12 shows an example of a connecting matrix that includes a crossbar switch configuration, in accordance with some embodiments.

FIG. 13 illustrates a system with each modular load bus connected to two modular generator buses, in accordance with some embodiments.

FIG. 14 shows modularized loads powered by modularized power plants and/or by a centralized power source, in accordance with some embodiments.

FIG. 15 shows a centralized power supply connected to the modular generator via a switch or bridge, in accordance with some embodiments.

FIG. 16 illustrates bridges that enable a central energy storage system (ESS) to be charged by a modular generator or any other part of a centralized power plant, in accordance with some embodiments.

FIG. 17 shows a centralized power supply connected through bridges to modular generators, in accordance with some embodiments.

FIG. 18 shows a modular generator with an ESS, in accordance with some embodiments.

FIG. 19 illustrates a system with a load-associated ESS that can serve a peak demand of a load, in accordance with some embodiments.

FIG. 20 illustrates a grid-forming resource bridged into a system of modular generators and modular loads, in accordance with some embodiments.

FIG. 21 illustrates a flowchart of a method to selectively route electrical power, in accordance with some embodiments.

FIG. 22 illustrates a flowchart of a method to jointly manage power generation and power consumption in a power distribution system, in accordance with some embodiments.

### DETAILED DESCRIPTION

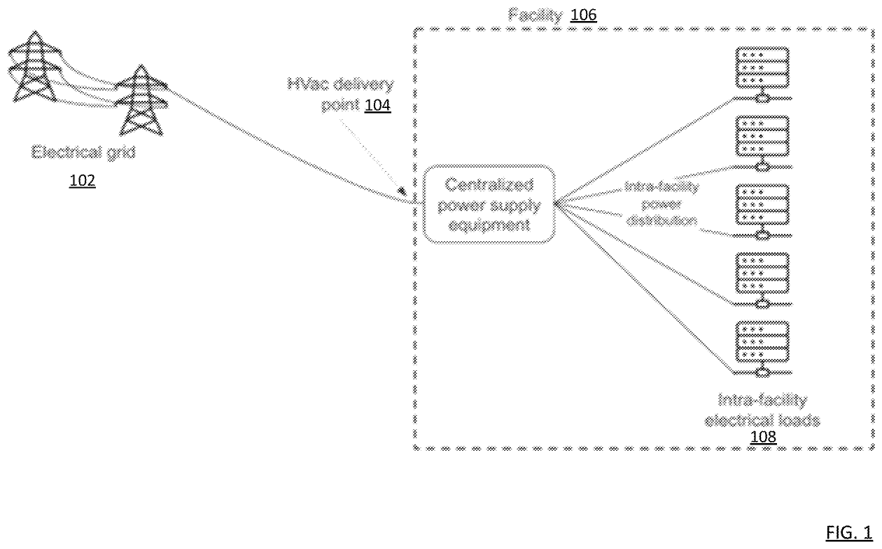

Many industrial facilities obtain electrical power from an electrical grid. As illustrated in FIG. 1, power from the electrical grid 102 can be delivered, as high-voltage alternating current (HVac), to a delivery point (the HVac delivery point 104) at an industrial facility 106, from which the facility's 106 power supply equipment processes the power (for example, lowers the voltage to safer levels) and distributes the power to the facility's 106 internal electrical loads 108 through an intra-facility power distribution system. The facility 106 typically does not communicate its electrical needs to a grid operator or otherwise coordinate its operation with that of the grid 102: the facility 106 instead draws electrical power as needed (e.g., up to a pre-established maximum power limit) and the grid operator is responsible for ensuring that the grid 102 maintains proper voltage and frequency at the HVac delivery point 104, making any adjustments in response to the power drawn by the facility 106.

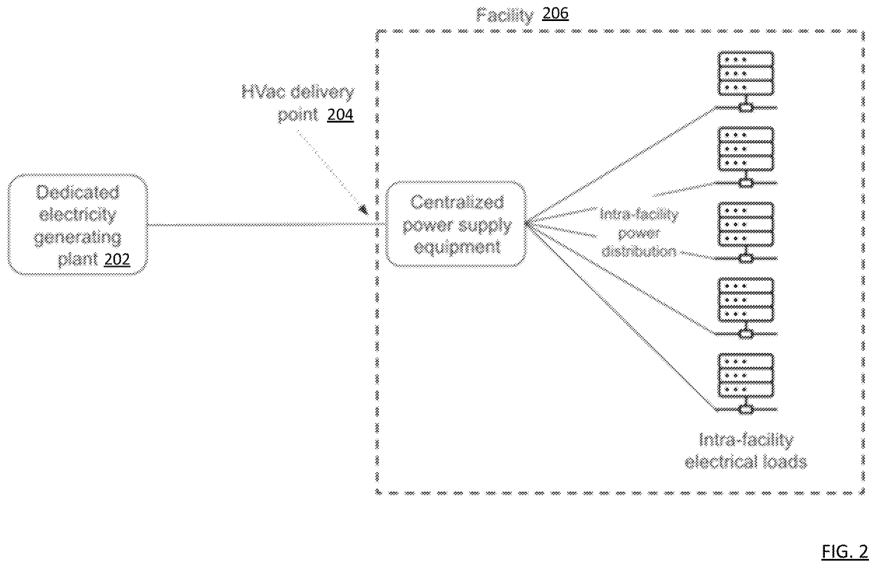

Some power-consuming industrial facilities can be designed to draw their electrical power from a dedicated electricity generating plant. FIG. 2 illustrates an example of this configuration. The electricity generating plant 202 can be designed to deliver power in the same HVac form at the HVac delivery point 204 as would be delivered by an electrical grid (e.g., electrical grid 102), so that the industrial facility 206 can use the same internal electricity processing, handling and distribution system as it would if it drew its power from an electricity grid.

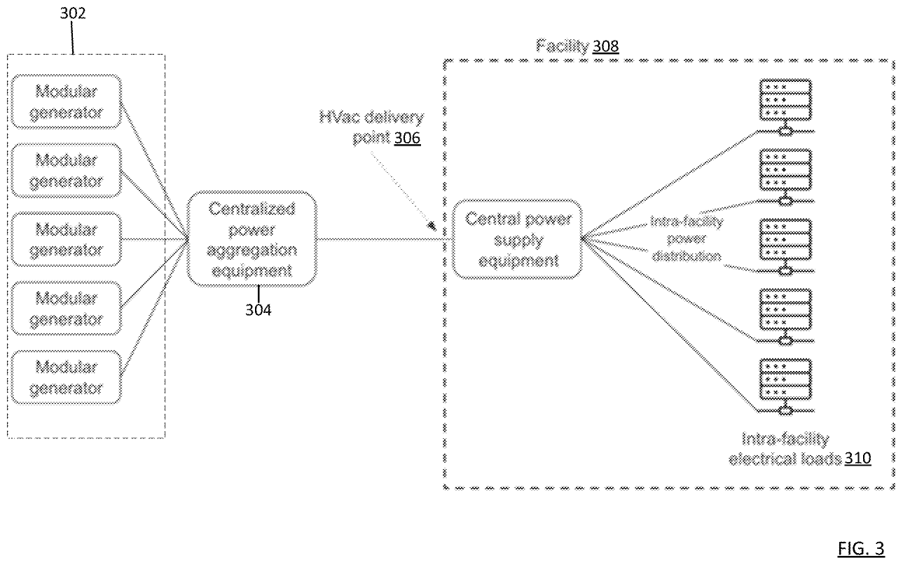

In some cases, the dedicated electricity generating plant (e.g., dedicated electricity generating plant 202) comprises a number of modular generators 302 (which could be or include, for example, diesel generator sets, wind turbines, and/or solar power plants), as shown in FIG. 3. The power from these modular generators 302 is typically aggregated by centralized power aggregation equipment 304 so that the power from all the modular generators 302 can be delivered to a single HVac delivery point 306.

The electrical architecture of FIG. 3 has the advantage that the interface at the HVac delivery point 306 is standardized, which enables the generating plant (e.g., dedicated electricity generating plant 202), on the one hand, and the electrical system within the facility 308, on the other, to be designed and operated independently. It also has the advantage that the available power/energy resources are effectively pooled at the delivery point 306, allowing the power/energy resources to be shared across the intra-facility electrical loads 310 with no, or minimal, need to allocate those resources explicitly.

Depending on the application, the architecture of FIG. 3 can be regarded as having some disadvantages. For example:
Converting power to high voltages is costly, often involving the use of specialized equipment.
Centralizing electrical power involves the use of locally large voltages and currents, which are dangerous and require specialized equipment to manage.
All the power flows through a single delivery point, which can be a “choke point.” Near that choke point, there are typically pieces of equipment that may be unique or that may have very limited redundancy, creating the potential for single points of failure that could completely or partially—but significantly—disable the system.
The multiple modular generators are synchronized so that their AC power outputs can be aggregated. Synchronization involves establishing a common AC frequency across all the AC power outputs and getting those AC power outputs to the same phase and voltage, as well as the same frequency. Doing so is not trivial: it involves implementing suitable equipment and control systems, which can be challenging to get to work correctly.
If the AC is generated by inverters, it is typically desirable that harmonics from the switches used in the inverters be suppressed. This can involve the use of significant amounts of electrical equipment to suppress harmonics at multiples of 50-60 Hz.
The assumption that the generators and loads can be operated independently of each other may not work well in practice if the generating capacity is comparable to the size of the load—and especially if the generating capacity is attempting to maintain a grid-standard AC power supply using inverter-based resources. Moreover, such a system may struggle to maintain AC power standards at the interface when black starting the facility 308 (e.g., powering up the facility 308 from an unpowered state), or if the electrical power drawn by the facility 308 changes substantially and quickly.

Where the generators are dedicated to the facility, it may be difficult to maintain grid AC standards at the interface so that the generators and loads can be operated independently of each other. Depending on the application, however, it may be acceptable for the generators and loads to operate in a manner that is not fully independent of each other.

In addition, the industrial facility can comprise a number (e.g., a large number) of modular electrical loads. For example, data centers can have highly modular loads at multiple levels of modularity, from server blade to rack to cage to floor to building.

The present disclosure, in accordance with some embodiments, presents approaches to distributing power from a set of modular generators to a set of modular loads under common control.

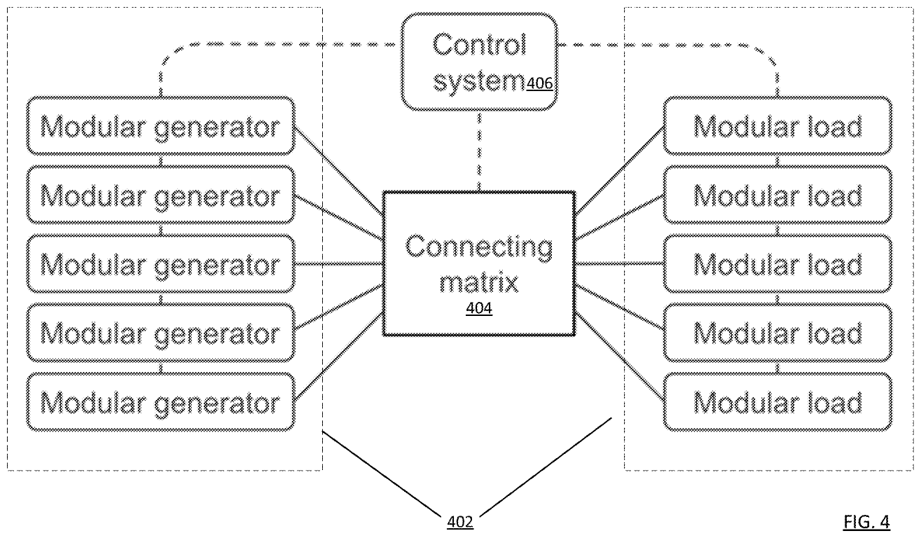

As an example, FIG. 4 shows the outputs of the modular generators 402 not centralized into a single path but instead kept separate (in a configuration referred to herein as a “generator swarm,” a “swarm generator,” or a “swarm power plant”)and led to a connecting matrix 404 (“connecting matrix” is also referred to as “connection matrix” herein) that enables the generator swarm to be more flexibly connected to the modular loads (sometimes referred to herein as “load” or “loads”) without concentrating the power into a path with high single-point-of-failure risk or the need to handle extremely concentrated power flows. Some of these more flexible connection arrangements are illustrated herein, in accordance with some embodiments.

As used herein, “hyperfirm” can refer, by way of example, to a commitment to delivery power with very high reliability (e.g., with a reliability that is higher than that of known power delivery systems). One or more embodiments set forth herein describe systems and/or methods that can provide hyperfirm power, optionally even after accounting for maintenance and/or unscheduled downtime.

In addition to the swarm generator, modular loads and connecting matrix, FIG. 4 also shows a control system 406 (e.g., implemented in hardware and/or software) configured to manage and control the connecting matrix 404, modular generators 402, and modular loads, hence with all these pieces of equipment under “common control” of the control system 406. The separation of the power paths can mean that there is no (or substantially no) physical pooling of power/energy resources, and as such, active control and intervention provide (allow) for the sharing of those resources (which assists in providing improved or optimal efficiency).

### MODULAR GENERATOR AND GENERATOR SWARM USING SOLAR POWER PLANT EXAMPLES

### Solar Photovoltaic (PV) Power Plant as a Modular Generator

Known solar PV power plants include a large number of solar panels or solar modules. Under some known standard conditions (e.g., lighting and temperature), each solar module can produce on the order of 500 watts (W) of power as of the date of this disclosure. Thus, a 1 megawatt (MW) solar power plant could have on the order of 2,000 solar modules. Each solar module produces an output voltage on the order of 50 volts (V) and an output current on the order of 10 amps (A).

Groups of solar modules (which can be referred to herein as “solar power plants”) can be connected in series in strings, where a single string of approximately 10 solar modules can generate a DC voltage of about 500V, or 20-30 solar modules can collectively generate a DC voltage of approximately 1,000 V to 1,500 V (or 1 kV to 1.5 kV).

To make the power output suitable for a centralized power system, the power from one or multiple strings can be supplied to an inverter, which is a type of Power Conversion System (PCS) that converts DC power to AC power. The resulting AC power output can then be supplied to a transformer, which can multiply the AC voltage by a fixed ratio (while simultaneously reducing the AC current by the same ratio). By arranging for the inverters to convert the DC power to AC power that is synchronized—e.g., in phase—it is possible to connect the outputs of the transformers together and combine all the power outputs into a single power outlet. This single power output can carry the entire power output of the solar generator or, as described herein, this single power output can constitute the output of a single module of a modular generator in a swarm power plant.

Because solar modules produce power only during the day and because their power output varies by time of day and depending on atmospheric conditions (including cloudiness), known solar power plants can incorporate energy storage systems (ESS) that can store energy when the solar plant produces more than the load uses and deliver that energy to the load when the load requires more power than the known solar plant produces.

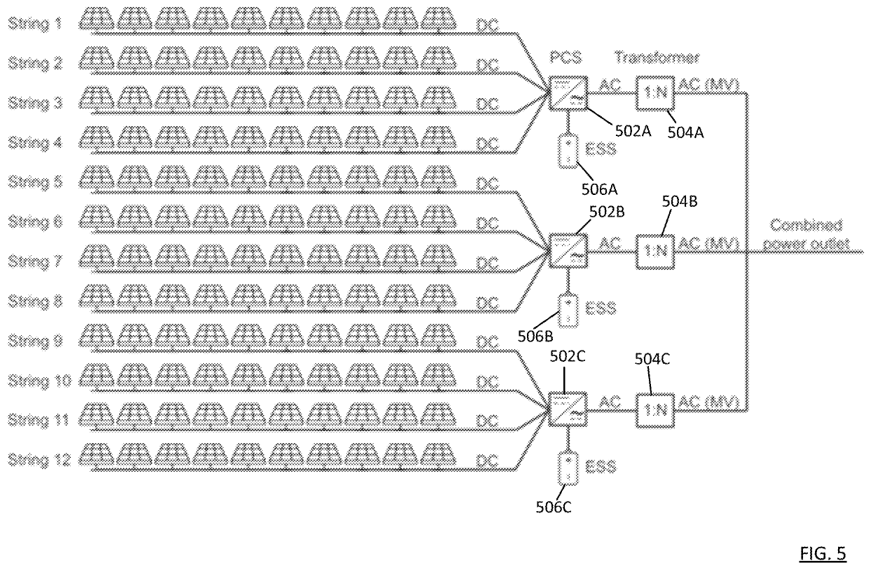

FIG. 5 shows an example system with twelve strings (Strings 1 to 12), each including ten solar modules. Each string can be referred to as a solar power plant. For each string, the solar modules of that string are connected in series so that their DC voltages add (in FIG. 5, to a voltage on the order of 500 V). The power from the twelve solar strings are sent to three inverters 502A, 502B, 502C, in this example, with four strings going to each inverter. Said similarly, strings 1 to 4 are coupled to inverter 502A, strings 5-8 are coupled to inverter 502B, and strings 9-12 are coupled to inverter 502C. The number of input strings to each inverter depends on the inverter design: while FIG. 5 shows four strings per inverter, similar configurations can have fewer or more strings per inverter. In some implementations, each inverter input uses a Maximum Power Point Tracking (MPPT) system, which finds/identifies the voltage at which the string produces the maximum amount of power under current lighting conditions, and then delivers that power to the inverter at the inverter's predefined or preferred input voltage.

The output of each inverter 502A, 502B, 502C goes to a step-up transformer 504A, 504B, 504C (respectively). The output sides of the transformers 504A, 504B, 504C are on a common bus, producing a resulting AC output with a medium-high voltage (designated by “MV” in FIG. 5). In FIG. 5 each inverter 502A, 502B, 502C also manages power flow to and from an operatively coupled ESS 506A, 506B, 506C (respectively); an alternative arrangement has a single ESS connected to the common output (AC) bus via a separate PCS and is referred to as an “AC coupled ESS” because the PCS is coupled to the solar power plant(s) by the AC output bus.

### Design of a Swarm Solar Power Plant

A solar power plant is highly modular, at the level of the solar modules and at the level of strings. A powerplant as illustrated in FIG. 5 can itself be viewed as a single modular generator that can be replicated. Thus, the solar power plant of FIG. 5—or variants of it—can become a single modular generator in a swarm power plant.

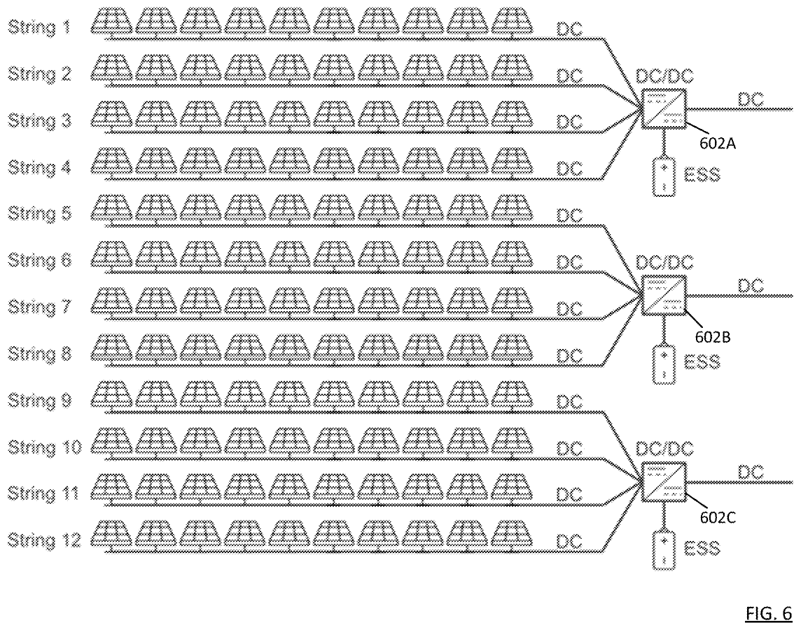

For example, FIG. 6 shows how twelve strings (Strings 1 to 12) of solar modules (each string having ten solar modules) can supply power to a swarm of three power modules 602A, 602B, 602C (with DC power outputs). Here, instead of inverters, the PCS devices 602A, 602B, 602C are DC/DC converters that accept DC inputs and deliver DC outputs: the input voltages and currents can vary over a wide range (for MPPT purposes, for example), while the output voltage can be substantially (e.g., within 1%, within 5%, within 10%, and/or the like) constant. By way of example, in the configuration shown in FIG. 6, the output voltage could be in the range of 30 kV or more. FIG. 6 shows four input strings per DC/DC converter 602A, 602B, 602C; depending on the specific DC/DC converter design, more strings or fewer DC/DC converters and/or strings per DC/DC converter can be used.

Although FIG. 6 shows energy coming only from solar power plants, a swarm can be alternatively or additionally be created with any modular generator, such as wind turbines and/or diesel generators (gensets).

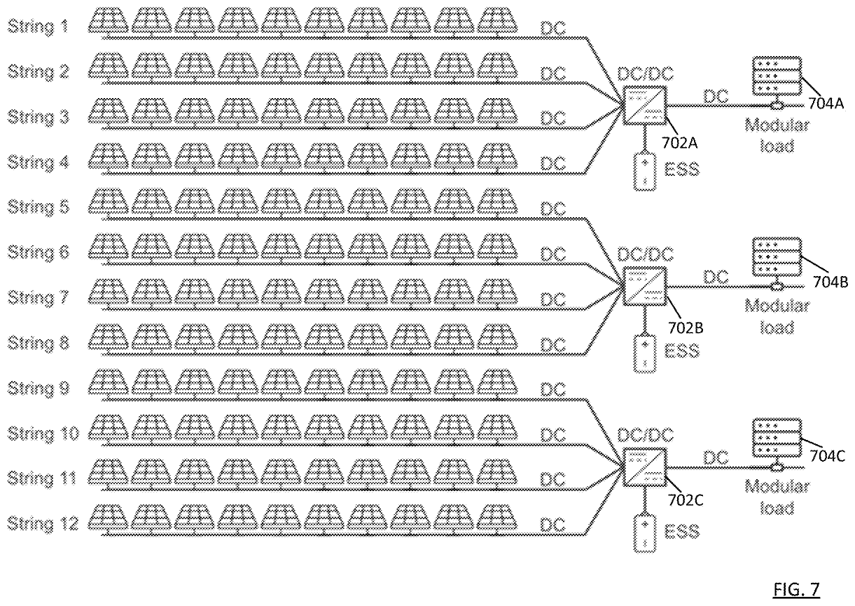

FIG. 7 shows another example of how the set of modular generators in FIG. 6 could be connected to modular electrical loads inside an industrial facility. In FIG. 7, each DC output from a modular generator 702A, 702B, 702C could provide power to an electrical bus from which a modular electrical load 704A, 704B, 704C (respectively) could draw power. As illustrated herein, other connection architectures may alternatively or additionally be used.

### CONNECTING MATRIX OPTIONS

In accordance with some embodiments set forth herein, the “swarm” architecture, in which the power that flows between modular generators and modular loads are not brought together at a single point, does not include or result in (and instead avoids) a global single-point-of-failure vulnerability, but can include single points of failure for each generator/load pair. In addition, the swarm architecture does not provide a natural (e.g., physical) pooling of power/energy resources, which can create limitations that are inconsistent with (and thus are impediments to) operating at improved (e.g., maximum) efficiency. If power is not transferred from a generator/load pair whose generator has a temporary excess of capacity to one that has a temporary shortfall, then all generators should be sized to meet the demands of their corresponding loads at all times; whereas, if power can be transferred between pairs, the total generator capacity can be made smaller and used more intensively, which is a more efficient use of resources and enables less total generator capacity to be used to serve the load at any service level.

In some implementations, to facilitate the transfer of power (and energy) between the generator-load pairs without physically pooling the power at a single point and creating single-point-of-failure risk, a connecting matrix (discussed further herein) can be used.

### Connecting Matrix 1: Pairwise Matching With Cross-Ties

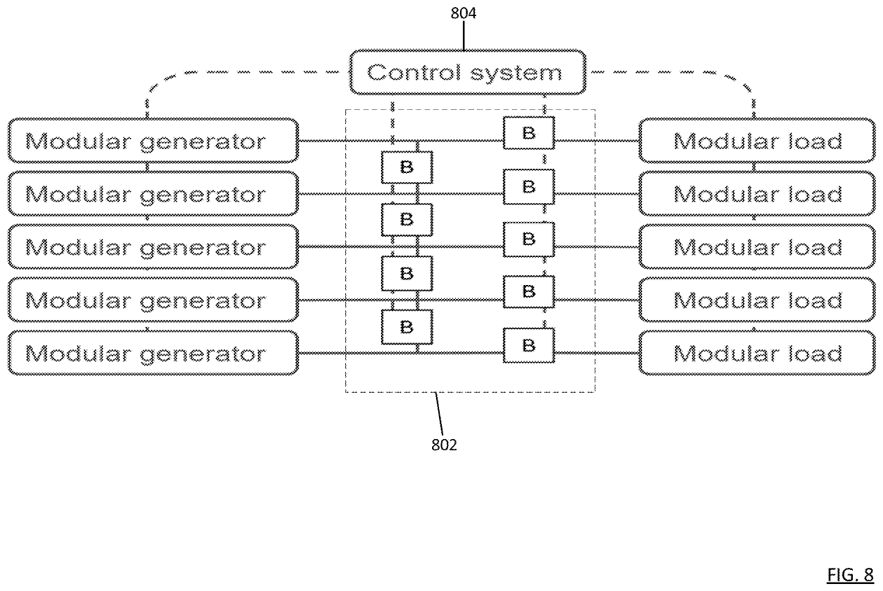

FIG. 8 shows an embodiment in which each modular generator can be connected to an associated modular load. In some implementations, the generating capacity of each modular generator is matched to the electrical demand of each associated modular load. A switch can be included to enable the operator to isolate the modular generator(s) from the modular load(s). The switch can be a mechanical switch or an electronic switch. An electronic switch can be an electronic switching device or can be implemented as part of the functionality of a more complex Power Conversion System (PCS) device such as a DC/DC converter, a DC/AC inverter, an active-bridge AC/DC rectifier or a frequency converter, depending on the nature of the power system. If appropriately designed, the PCS device can be configured to control the amount of power transferred through it. Stated another way, the PCS device can operate in a more controlled manner and not simply act as a binary switch. Such devices are referred to herein as “bridges” (B).

In addition, FIG. 8 also shows bridges 802 between the modular generators, or “cross-tie bridges.” If these bridges 802 block power flow, then each modular generator can power each associated modular load in a standalone configuration when it is useful or configured to do (as the modular generator can be, for example, during system startup). If all the cross-tie bridges 802 allow power to flow without restriction, any modulator generator power fluctuations can be distributed across all the modular loads (rather than more strongly impacting a single modular load) and a modular load power demand fluctuations can be distributed across all the modular generators (rather than being borne more strongly by a single modular generator).

Furthermore, by controlling the power flows through the cross-tie bridges 802, the controller 804 can ensure that power from one particular modular generator is split between two particular modular loads and not distributed to modular loads connected to intervening power buses. For example, power from the first modular generator bus can be delivered in part to the first modular load and sent through the cross-tie to the second generator bus and then on to the third generator bus, where the power can be delivered to the third modular load. Although this power flows to the second generator bus this power may not power the second load because power flowing to the third bus from the second bus can be controlled by control system 804 to be equal to the power flowing to the second bus from the first bus.

The system shown in FIG. 8 can be implemented where the power output of each modular generator is AC; or the system shown in FIG. 8 can be implemented where the power output of each modular generator is DC, with appropriate electrical design of the modular generators, modular loads and bridges 802.

### Connecting Matrix 2: Balancing Bus

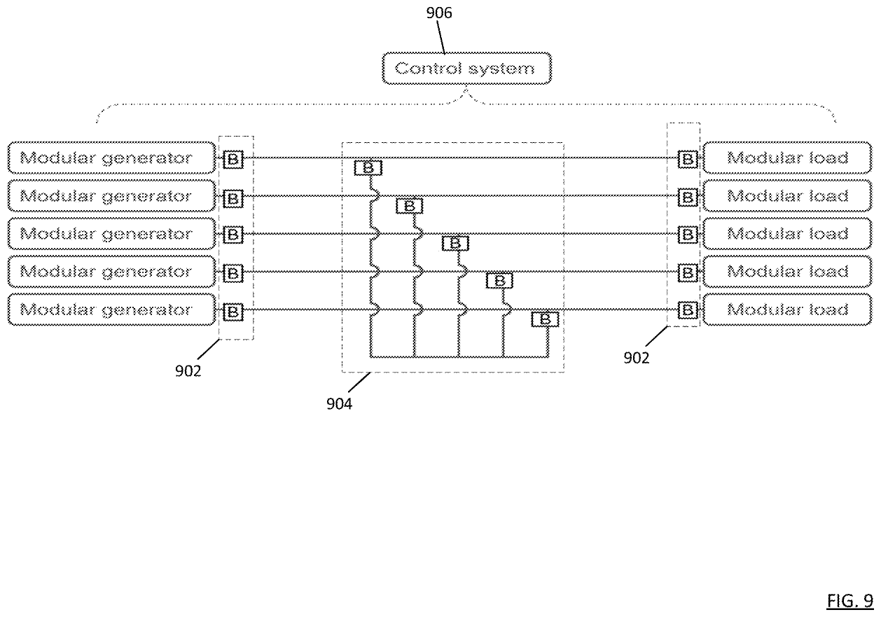

FIG. 9 shows an example of a connecting matrix based on a balancing bus. In this form of connecting matrix, each modular generator/modular load pair are directly connected by a modular bus. For operational reasons the modular bus can contain bridges 902 (“B”). FIG. 9 shows bridges 902 that can manage power entering each modular bus from its associated modular generator, and can also manage power delivered by each modular bus to its associated modular load. In addition to the modular buses, there may be a balancing bus 904 and each modular bus can be connected to the balancing bus 904 via an associated bridge from a plurality of bridges 902.

The balancing bus 904 can serve at least two functions:
The balancing bus 904 can serve a balancing role (hence its name), enabling the transfer of power from under-loaded modular generators of FIG. 9 to under-served modular loads of FIG. 9; and enabling the transfer of energy between energy storage systems on the network either while also serving loads or when the loads are partially or entirely offline.
The balancing bus 904 can serve a redundancy role, aggregating power from multiple modular generators of FIG. 9 to distribute to one or more of the modular loads of FIG. 9.

When the balancing bus 904 is performing either (or both) functions, the ability to control power flowing through the bridges 902 enables the control system 906 to fully and/or actively manage power flows through the system shown in FIG. 9. For example, suppose the first modular generator in FIG. 9 can produce more power than the first modular load requires or uses. The excess power can be distributed to, for example, the second, fourth and fifth modular loads, but not to the third, by controlling the bridges 902 to allow power to flow from the first bus to the balancing bus 904 and from the balancing bus 904 to the second, fourth and fifth buses—but not the third. In addition, the excess power from the first modular generator can be distributed in unequal proportions to the second, fourth and fifth modular loads by controlling the power flow through the corresponding bridges from the balancing bus 904.

The balancing bus 904 adds wiring and bridge devices to the system shown in FIG. 9. If there are M main buses (e.g., where M is a non-zero, positive integer), the balancing bus can include M bridge devices.

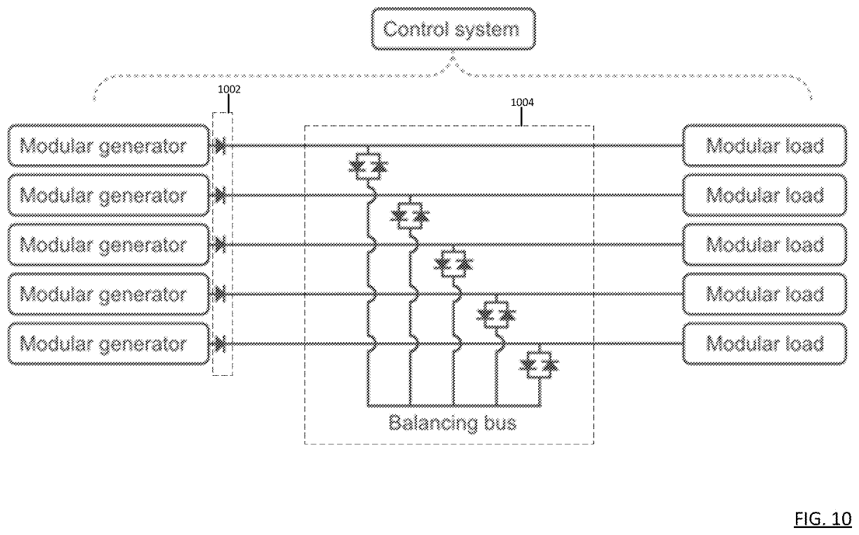

As shown in FIG. 10, in a DC electrical system, an emergency failover system can be implemented using electrical diodes 1002 (of suitable power capacity) and a balancing bus 1004 arrangement. If the voltage on a modular bus falls due to a failure or other event (which can be partial) of a modular generator, the electrical diodes 1002 can allow power to flow over/through the balancing bus 1004. The electrical diodes can also prevent this power from flowing back into the failed modular generator.

### Connecting Matrix 3: More Than One Balancing Bus

The balancing bus, in accordance with some embodiments, can ensure that there is not a single local point of potential failure even at the level of the generator/load pair. The balancing bus provides, however, only a single alternative power path and can impose restrictions on the possible balancing/redundancy power flows.

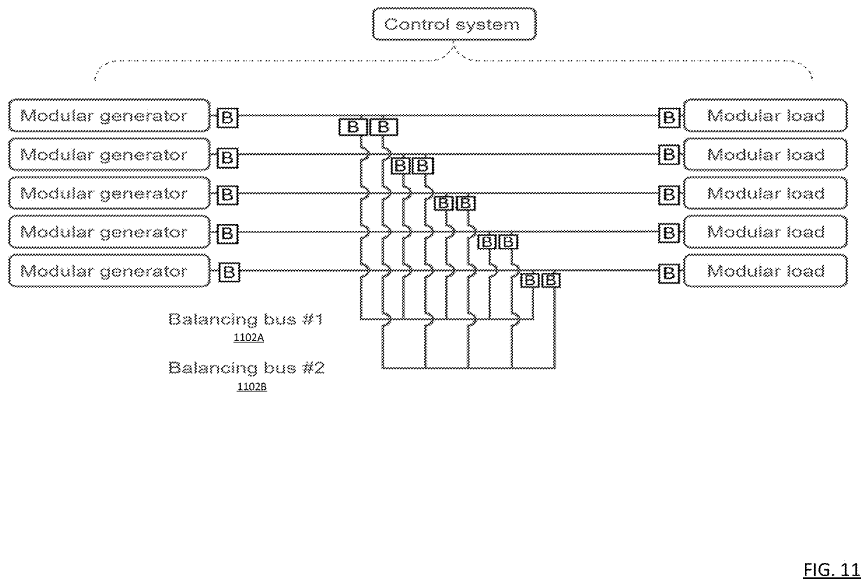

In some implementations, as shown in FIG. 11, a second balancing bus can be added, which again increases the number of bridges used by M. FIG. 11 shows the resulting configuration, which includes balancing buses 1102A and 1102B and bridges (“B”) between the modular generators and modular loads.

In some implementations, one or more balancing buses (e.g., a third balancing bus) can be added to the system shown in FIG. 11 to provide additional redundancy and, if desired by practical limitations in controlling the bridges (“B”), to provide additional flexibility in managing power flows. Ultimately, in principle, any number of balancing buses can be used. The total number of bridge devices included in a given balancing bus system can be defined by N×M, where N is the number of balancing buses and M is the number of modular generator/load pairs.

### Connecting Matrix 4: Full Crossbar Connection

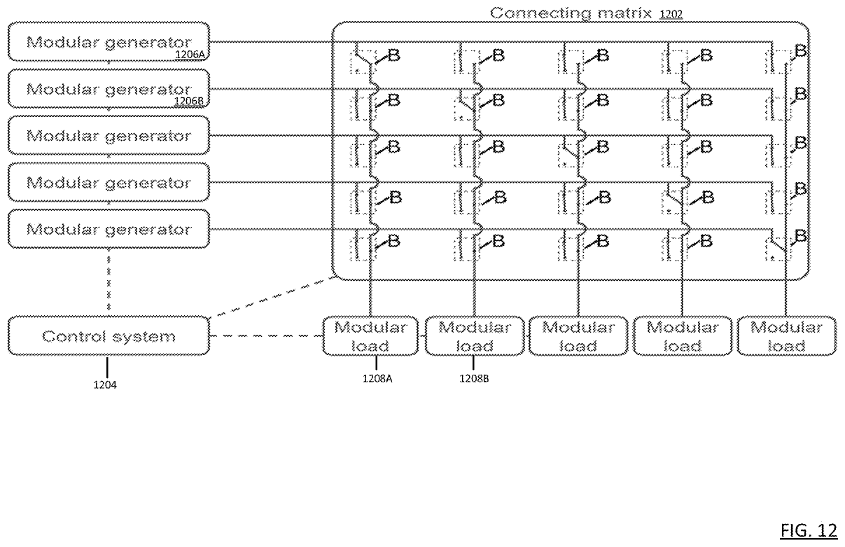

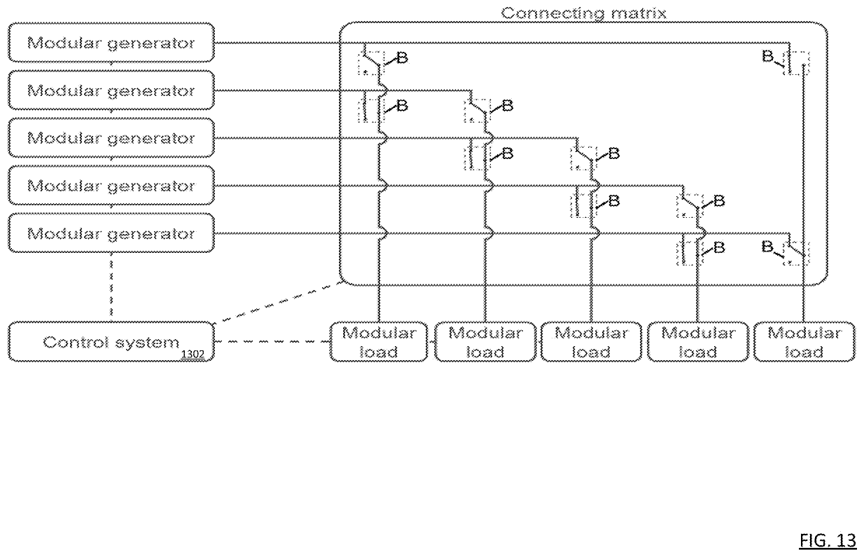

For completeness and in contrast, note that the connecting matrix can be implemented using a crossbar switch configuration. FIG. 12 shows an example of a connecting matrix 1202 that includes a crossbar switch configuration, which allows any combination of modular generators to be connected to any combination of the modular load(s). Each modular generator supplies power to an associated generator bus; and each modular load draws power from an associated load bus; and a set of controlled bridges (“B”) at connecting matrix 1202 can be controlled by control system 1204 to enable any generator bus to deliver power to any modular load bus. In FIG. 12, to illustrate the concept, the bridges (B) are shown using switch symbols to show which bridges allow power to flow and which do not, but other implementations can use controllable power conversion systems rather than binary switches. This approach is re-used in FIGS. 13-20. In FIG. 12, the top-most left-most bridge (B) of the connecting matrix 1202 allows power flow, connecting the generator bus for the first modular generator 1206A to the load bus for the first modular load 1208A; the second-from-left bridge in the second row allows power flow, connecting the generator bus for the second modular generator 1206B to the load bus for the second modular load 1208B; and so on. FIG. 12 can be implemented for a DC power system design or an AC power system design, with appropriate electrical design of the modular generators, modular loads and bridges.

### Connecting Matrix 5: Partial Crossbar Connection

In some embodiments, a number of bridges can be reduced (e.g., compared to FIG. 12) in a partial crossbar configuration, an example of which is illustrated at FIG. 13. This partial crossbar configuration enables each modular load bus to connect to only a subset of the modulator generator buses via bridges (B), as shown in FIG. 13, which shows an example where each modular load bus can connect to two modular generator buses. In other implementations, however, each modular load bus can connect to more or less than two modular generator buses via more or less than two bridges.

Assuming controllable bridges (e.g., controlled by the control system 1302), the balancing and redundancy capabilities of the balancing bus configuration can be desirable for a given number of bridge devices.

### JOINT CONTROL OF THE GENERATION, LOAD AND CONNECTING MATRIX

In some embodiments, the modular generators, modular loads and connecting matrix are all located relatively physically close to each other, and thus efficiency can be improved (e.g., maximized) by putting the modular generators, modular loads and connecting matrix under common control.

### Controlling the Load: Example

As a first example, a power system configured for industrial loads can be operated with an objective of supplying power as demanded or used by the load. In this operating approach, the modular loads can set their power draws and the modular generators can be directed to supply power to meet that collective load. If, however, the power and/or energy available from the modular generators is temporarily lower than the power that the modular loads could accept, the control system can direct (e.g., by sending an electronic signal to) the modular loads to reduce their power draws and avoid drawing more power than the generating system can supply. It can therefore be advantageous to be able to control the modular loads.

### Controlling Modular Generators and Modular Loads: Example

In some embodiments, it can be the case that the modular generators could deliver power equal to what the modular loads uses or could accept, but that if the modular generators did so they would draw down the energy in their ESS with the result that, at some later time, the control system forecasts that the modular generators would have to reduce their output power below some minimum desirable threshold. By reducing the power demanded by the modular loads before that forecasted moment, the energy in the ESS can be conserved, enabling the modular generators to deliver at least the minimum desirable amount of power at the later time. This can be facilitated by controlling (e.g., by a control system) the modular loads and the modular generators.

### Controlling Modular Generators and Modular Loads With a Priority Order for Loads

Alternatively or additionally, there can come a time when, efforts to conserve ESS energy notwithstanding, the modular generators are unable to deliver the minimum desirable amount of power to the modular loads. A system with common control can be configured to prioritize loads, so that lower-priority modular loads can be shut down while higher-priority loads continue to receive power and operate. This can keep the total load within the reduced available power and reduce (e.g., minimize) danger of failing to supply sufficient power to high-priority loads. Again, the modular loads and the modular generators can be controlled by a common control system.

### Controlling Modular Generators and Modular Loads to Improve ESS Capacity Requirements

In general, a forecast (e.g., by a control system) of energy production by the power plant can predict times when the power plants can produce more power than the loads can absorb, enabling the power plants to charge the ESS; while at other times, when the power plants produce less power than the loads use or need, the ESS can be discharged to supply the loads. At times, however, the energy that can be charged to the ESS is limited by the remaining, uncharged capacity of the ESS, so that during the period when excess power can be produced, there can be nowhere to store all or some of the excess power. In such a situation, if each load can be controlled to reduce its power demand during the time when the ESS are being discharged and increase its power demand when the power plants would charge the ESS, the amount of energy to be time-shifted by the ESS can be reduced, reducing the impact of the capacity limits of the ESS and allowing more total energy to be transferred to the loads. This is another example where the modular loads and the modular generators can be controlled by a common control system.

### Transferring Energy Between ESS by Controlling Modular Generators and Connecting Matrix

In the preceding example, the modular generators, the ESS and the modular loads are described as operating in parallel, with excess power being produced by all the generators at some times, and the ESS all being discharged to the loads at other times. Power production by the modular generators, however, can vary, so that different power plants can produce different amounts of power at the same time. For example, one modular solar generator can be affected by the shadows of clouds or trees more than another. Further, modular loads can draw different amounts of power at the same time; for example, in a data center some sections of the data center can be heavily loaded by tasks while others are less heavily loaded. The connecting matrix can be controlled (e.g., by a control system) to help address this by transferring power from buses where energy production exceeds the power demanded by the load to those where the load power demanded exceeds energy production; this controlling of the connecting matrix can transfer energy from buses where the ESS are more fully charged to those where the ESS are at a lower state of charge. Both the connecting matrix bridges and the PCS devices that manage ESS charging/discharging within the individual modular generators can be controlled (e.g., by a control system). At the same or different time, the control system can also modify load profiles, directing loads that are demanding or using larger amounts of power to defer a portion of their demand or usage from times when energy production is lower to times when energy production is higher. After taking all these coordinated steps to improve or optimize the delivery of energy produced by the modular power plants to the modular loads, the control system can further direct adjustments to the total energy demanded or used by the loads across a longer period of time (such as a day or more) in response to forecasts of total energy produced by the modular power plants.

### JOINT CONTROL CAN BE USEFUL

In some implementations, when a balancing bus is being used to transfer energy from an under-loaded generator to a depleted energy storage subsystem, the control system can direct the relevant PCS devices to direct a certain amount of power from the under-loaded modular generator to its corresponding modular load and also to direct additional power from that generator to a balancing bus, while directing that additional power into the ESS device(s) to be charged. The relevant PCS devices can be entirely located in the connecting matrix; or one or more of the PCS devices can be located in the modular generators (controlling power drawn from the modular generators), one or more in the modular load, and/or in the connecting matrix. It can be desirable in some instances to control power flows and energy transfers throughout the overall system, rather than attempting to do so in only part of the system, while excluding other parts.

### DESIGN CONSIDERATIONS

### Using Controlled Bridges to Address Electrical Engineering Considerations

If multiple modular generators can be electrically connected to any selected modular load, a question that can arise is whether the conductors in the modular load bus should be sized to handle the sum of the maximum currents that could be delivered by each of the modular generators. That is, whether the conductors in the modular load bus should be sized to handle a current of M×Iₘₐₓ, where Iₘₐₓ is the maximum current that can be delivered by a single modular generator and M is the number of modular generators. Since this much current would presumably exceed the maximum current limit of a single modular load, sizing the conductors for that much current could result in excessively large conductors throughout the switching matrix and bus system. If the conductors are not sized this way, however, it is desirable to ensure that large currents do not flow through the conductors and the loads do not receive current beyond their acceptable current limits. In addition, a potential risk of a short circuit exists, especially in DC systems there are typically practical limits to how large a current can be disconnected by a switch or even an emergency circuit breaker, making short circuits potentially challenging to control.

This is where the use of bridge devices (e.g., instead of switches) in at least part of the electrical system can be helpful. For example, in a DC system, bridge devices can be constructed as galvanically-isolated dual-active bridge (DAB) DC/DC converters. DAB DC/DC converters have DC inputs and outputs but use internal switching systems to create high-frequency AC inside the device. This AC is transmitted from one side of the device to the other through a transformer, which provides complete DC isolation of the output from the input. Any stoppage of the internal switching system—whether shut down by a control system or due to a failure (e.g., open or short circuit) of an internal switch—will cause the generation of AC inside the device to stop and little to no power will flow across the internal transformer. Consequently these devices can act as safety disconnects.

In addition, by controlling the duty cycle of the internal switches it is possible to obtain finer control of the amount of power transmitted from the input side to the output side, so that as long as the device continues to operate properly the device can be used to manage (e.g., by a control system) the flow of power with more precision. The duty cycle control system can use a power meter (or a combination of voltage and current meters) in a closed-loop system for this purpose, and the target power flow can be established by the system-level controls; further, a safety-oriented supervising system can shut down the switching system altogether if the closed-loop system fails to keep power flows within predefined and/or desired limits.

The galvanically-isolated DAB DC/DC converter is an example of how PCS devices generally can be used to manage, control, limit and—in some cases—stop power flow at key points in the connecting matrix. Both DC power systems and AC power systems can be effectively controlled by active PCS devices.

In a signal-switching context that uses switching matrices, such as crossbar configurations, currents are typically on the order of milliamperes and the primary design constraints relate to signal integrity, crosstalk, and bandwidth. In a power distribution context, by contrast, currents can be on the order of kiloamperes, and the design of the connection matrix is driven by considerations including the current-carrying capacity and thermal limits of conductors, the ability of switches or bridge devices to safely interrupt fault currents (such as short-circuit currents), and the management of power flows to prevent conductors or switching devices from exceeding their rated capacities. These considerations can influence the selection and design of bridge devices (such as the galvanically-isolated DAB DC/DC converters described herein), the sizing of conductors within the connection matrix, and/or the design of the control system that manages power flows through the connection matrix.

The use of PCS devices can also help with the implementation of safety protections. Earth leakage current measurements, voltage and current meters and the like can be incorporated in the electrical circuit design. Safety controls can monitor these readings and, on detecting an unsafe condition, can trigger a shutdown of the appropriate PCS device(s). This can shut off the power on a timescale comparable to a cycle of the relevant internal operating frequency, and potentially as little as half a cycle. For an example AC system, half-cycle shutdown could disconnect an offending power path within 8-10 ms. A PCS device can enable a substantially faster shutdown: in a PCS device the internal AC frequency can be on the order of 1-10 kHz, potentially enabling an effective shutdown of the offending power path in about 50-500 μs.

### CONNECTING A CENTRALIZED POWER SUPPLY, IN ADDITION TO THE SWARM GENERATOR, TO THE MODULAR LOADS

A centralized power supply is a power supply that is not modularized. The centralized power supply can be an electrical grid and/or a backup generator. Note that a centralized power supply can incorporate modular units: for example a backup generator can comprise several diesel generators, or the centralized power supply can derive power from a solar power plant that, although highly modular in its construction, has been centralized and delivers high-voltage (or medium-voltage) AC or DC power to a single point.

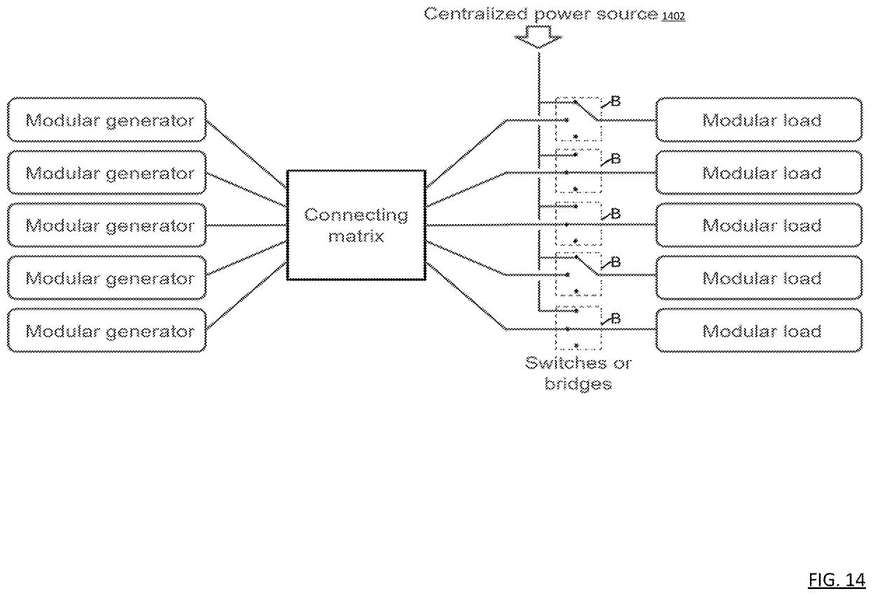

FIG. 14 shows an embodiment that enables the modularized loads to be optionally powered by modularized power plants and/or by a centralized power source. The centralized power supply 1402 sends power to a bus, and bridges (“B”) enable that bus to be connected to any one or any combination of the modular loads. Although not shown in FIG. 14, a control system can be operatively coupled to any one or more devices shown in FIG. 14.

The example in FIG. 14 can be implemented for a DC power system or an AC power system, with appropriate design of the electrical systems of the modular generators, centralized power supply, modular loads and connecting matrix.

### CONNECTING A CENTRALIZED POWER SUPPLY TO THE MODULAR GENERATORS

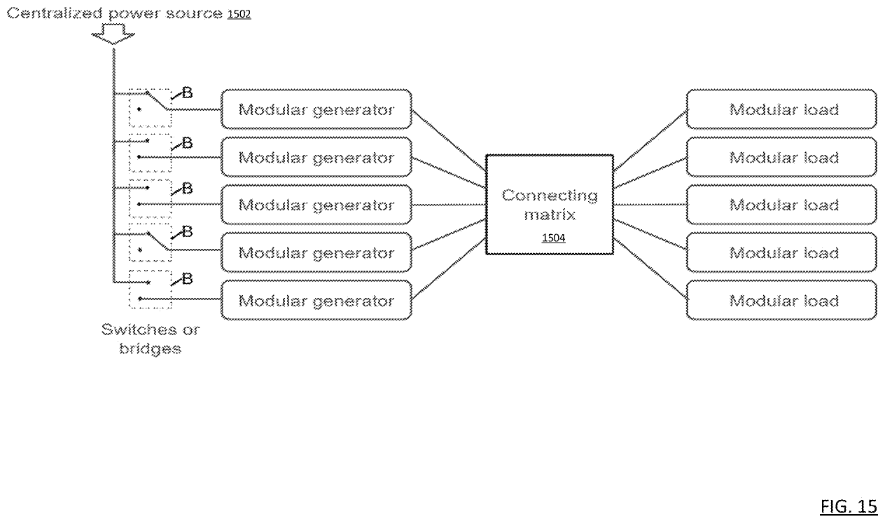

FIG. 15 shows an embodiment in which the centralized power supply 1502 can be connected to any of the modular generator(s) via a switch or bridge (B). The modular generator can then commingle energy from the centralized power supply 1502 with energy from the modular generator to provide power to the modular load(s) to which the modular generator is connected by the connecting matrix 1504. Although not shown in FIG. 15, a control system can be operatively coupled to any one or more devices shown in FIG. 15.

The example in FIG. 15 can be implemented for power supplies that use DC or AC, with appropriate design of the electrical systems of the modular generators, centralized power supply, modular loads and connecting matrix.

### INCORPORATING ENERGY STORAGE IN THE CENTRALIZED POWER SUPPLY

Although energy storage systems are inherently modular, some embodiments can combine energy storage systems to act as, or as part of a centralized power supply.

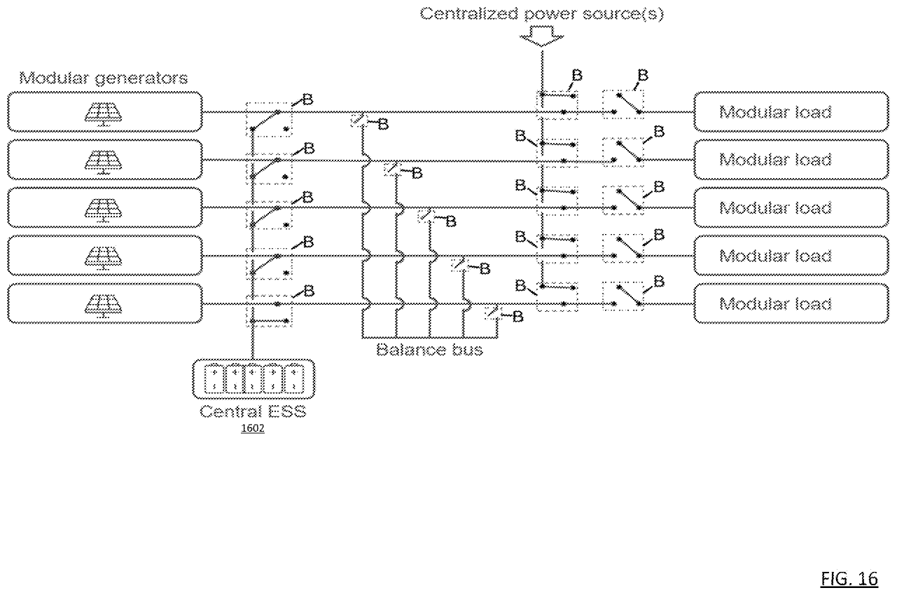

FIG. 16 shows such an embodiment. Bridges “B” enable the Central ESS 1602 to be charged by any of the modular generators or by any other part of the centralized power plant. Bridges also enable the central ESS 1602 to deliver power to any combination of modularized loads. Although not shown in FIG. 16, a control system can be operatively coupled to any one or more devices shown in FIG. 16.

### ADVANTAGES OF JOINTLY-CONTROLLED SWARM POWER AND MODULARIZED LOADS

### Increased Reliability

### Ability to Avoid Single Points of Failure and Isolate Faults

The swarm architecture avoids sending all the power flows through a single delivery point or single power flow path. Such a single point/path can create a “choke point” around which there are pieces of equipment that can be unique or have very limited redundancy, creating the potential for single points of failure that could completely or partially—but significantly—disable the system.

Within the architecture of embodiments described herein, the connecting matrix and/or control system can route power around equipment failures.

### High Reliability Without Using Separate UPS

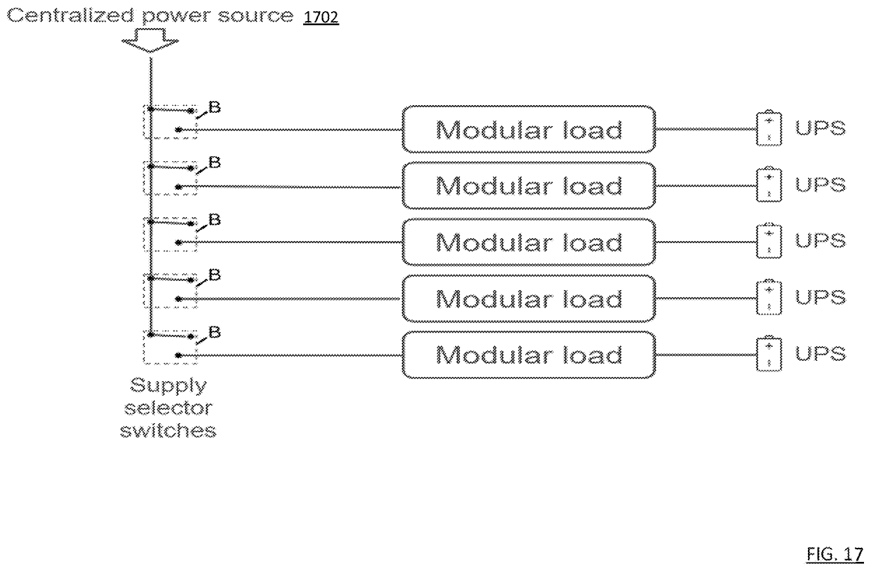

Modular loads with high reliability requirements, such as data centers, often incorporate uninterruptible power supplies (UPS) in their system design (see, e.g., FIG. 17, which is discussed in more detail herein). A UPS can include ESS capacity and an inverter, enabling the ESS to deliver AC power. Each UPS can be connected to the AC power bus that supplies a corresponding modular load. Optionally, a UPS can deliver DC power (e.g., using a DC-DC converter or voltage regulator rather than an inverter) and can be connected to a DC power bus for a corresponding modular load. The ESS within the UPS can be kept fully charged using energy from the centralized power supply, as needed.

When a modular load does not receive power from the centralized power supply, either because the centralized power supply is not operating or because the modular load has been disconnected from the centralized power supply, the UPS can supply power to the modular load to enable the modular load to continue operating until an alternative power source can be connected to the modular load, or to enable the modular load to be shut down in an orderly fashion.

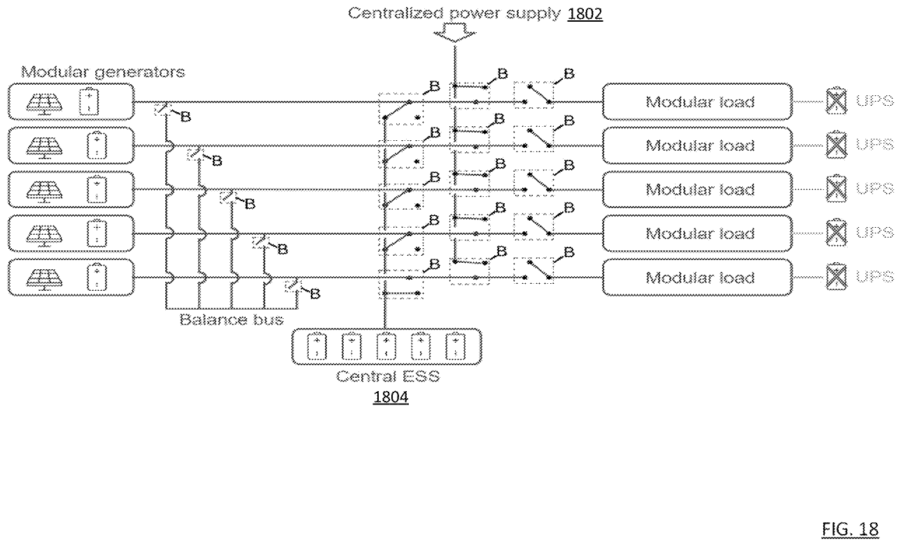

In the swarm architecture, in implementations where the ESS capacity is associated with the modular generators, the energy stored in each ESS can be used to maintain power to one or more modular loads, eliminating the need for separate UPS systems. FIG. 18 shows an embodiment that incorporates both modular generators with their own ESS and a central ESS—but no UPS. Embodiments with the ESS capacity either in the modular generators or in a central ESS, or in both, are possible. Although not shown in FIG. 18, a control system can be operatively coupled to any one or more devices shown in FIG. 18.

### Designing to be Reliable Through Redundant Modularity

A system with many modular generators can be designed for higher reliability, relative to a system with a single, centralized power plant.

Electrical grids can be unreliable in some industrial processes (data centers, for example, require very high levels of availability). To address the potential for a failure of the electrical grid, known facility designs incorporate redundancy features: diesel engine or gas turbine generating capacity to provide power when the grid does not; and UPS systems to provide power while the fossil-fueled generators start and synchronize. Fossil generating capacity can, in turn, comprise several separate generators whose total capacity exceeds the required capacity, so that the facility would be able to continue operating even if one of the fossil generators should fail to operate.

The use of modular solar and storage power plants allows reduction (e.g., elimination) of the UPS because the power plants already contain battery capacity; but, beyond that, the use of modular generators means that if one of the power plants fails, most of the power capacity remains. If the remaining modular generators can deliver all the power the system needs, the system can survive the loss of a single modular generator with little to no impact to operations. Similarly, the modular generator system can be designed so that it can meet the full power for all the loads even if two modular generators are offline, which is a much less likely event than one modular generator being offline. Indeed, the overall power supply system can be designed for any required level of reliability by ensuring that the facility could continue to operate without interruption if up to N modular generators should fail, where the probability of N modular generators failing simultaneously is low enough to ensure the reliability goal. So, if P(N) is the probability of at least N modular generators failing simultaneously, the reliability R of the facility can be R=1−P(N). Any specified value of R (for example, 99.9999%) can be achieved by increasing N to the point where P(N) is sufficiently small (in this example, <0.0001%) and by ensuring that the total number of modular generators in N larger than the number used to provide sufficient power.

### High Reliability in a Modular System Through Load Prioritization

In the event that the maximum or desired number of tolerable generation shortfalls should occur simultaneously, the power plant would fail to deliver the expected amount of power. A highly modular system with common control offers the opportunity to prioritize loads, so that lower-priority loads can be shut down while higher-priority loads continue to operate, thus keeping the total load within the reduced available power.

An embodiment of a load prioritization includes assigning (e.g., by a control system) prioritization levels to modular loads. In the event of a shortfall of delivered power, modular loads with the lowest prioritization levels could be shut down, resulting in a reduction in the total electrical load; additional modular loads with higher prioritization numbers could be shut down in sequence until the total electrical load can be satisfied by the available power. Modular loads can be assigned unique prioritization numbers, or modular loads can be assigned duplicate prioritization numbers so that they would be taken offline at substantially the same time.

An embodiment of a load prioritization could include the assignment of priorities, described herein, and identification of any modular loads not online for some other reason. If some modular loads are offline for other reasons (e.g., for maintenance), the control system can reduce the number of modular loads that are taken offline to match total load to the delivered power, keeping modular loads online with prioritization numbers lower than would otherwise have been possible.

Modular loads can be controlled directly if the loads are designed with control inputs for the purpose, or can be controlled indirectly by directing PCS devices to limit power flow, shut off power to the loads or by activating circuit breakers that prevent power flow to the loads.

### LOWER EQUIPMENT COSTS

In an electrical power system design having a single point of connection between the generators and the electrical loads, large amounts of power are transmitted over a single path. To reduce (e.g., minimize) resulting electrical currents and resistive losses, this can involve the use of very high voltages on the single path. High voltages are inherently dangerous and typically involve specialized equipment to manage them. High currents also typically use high-capacity equipment to manage them. These types of equipment are often expensive. By greatly reducing the concentration of power flows, the swarm power/modular loads design helps to reduce overall equipment costs by keeping peak currents and/or voltages lower.

### Use of Both Generator-Associated and Central ESS

The presence of ESS associated with each modular generator, and a central ESS (e.g., central ESS 1602 in FIG. 16) can enable the use of lower-power circuitry and thus a more efficient use of resources and lower equipment costs. Consider, first, a system with only a central ESS, but no ESS associated with each modular generator. If the modular generators are from renewable energy such as solar, then it can be desirable for the central ESS to store energy produced by each modular generator at peak production times, and for the electrical equipment (e.g., wiring, switches, etc., constituting each bus) between the modular generators and the central ESS to be large enough to carry power at peak production rates. Now, if ESS are added to the system at each generator, then those ESS can be used to store energy that is produced during times of peak power generation and only the amounts demanded by the loads are transmitted through the buses, allowing the design to use lower-power equipment in the buses. To enable this to work, the ESS associated with each generator has capacity to receive energy during those peak hours, so the ESS will be discharged during low-generation hours, by sending the energy to the load and/or central ESS during those hours.

In addition, if the loads demand variable amounts of power, including demanding peak power for relatively limited periods, then the buses up to the central ESS can be sized for power at below-peak levels. The buses from the central ESS to the loads can be sized for peak levels. Then, during peak power demand, the central ESS can augment the (limited) power from the generator.

### Peak-Serving UPS

Another example of how the swarm design can reduce equipment costs involves associating an ESS with each modular load. A UPS can be viewed as an ESS associated with a modular load. However, if that ESS is also under common control with the modular load, modular generator, balance bus, etc., the ESS can further improve efficiency of the system by reducing the power rating required of or used by the electrical bus (and associated equipment) between the modular generator and the corresponding modular load.

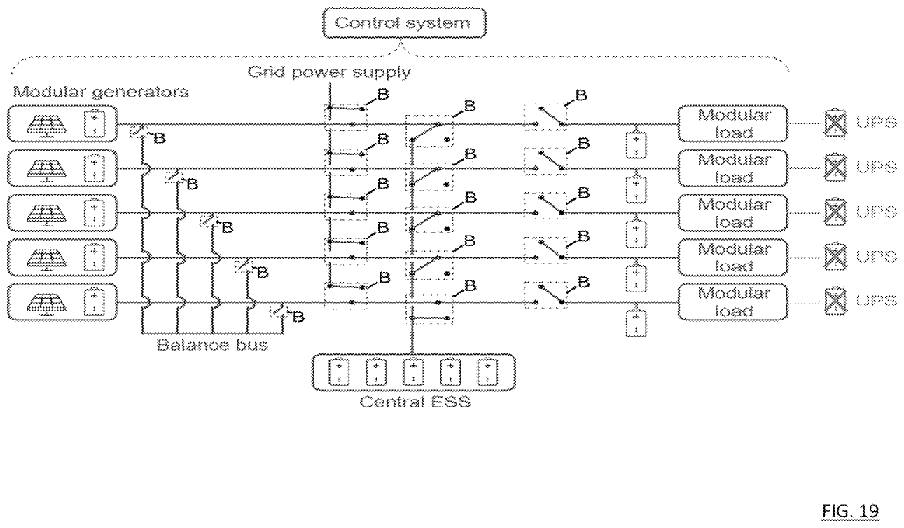

The load-associated ESS can serve the peak demand of the load so that the electrical bus does not need to carry power at this level between the modular generator and/or central ESS and the load. FIG. 19 illustrates an example embodiment. Although communication paths for the control system are omitted from FIG. 19, there is common control over the modular generators, modular generator ESS, balance bus, grid power supply bridges, central ESS bridges, main bus bridges, load ESS and modular loads.

### LOWER ELECTRICAL LOSSES

By reducing the number of Power Conversion System (PCS) and low-frequency transformer steps involved in the overall power path from modular generators to modular loads, electrical losses can be reduced.

### ADVANTAGES FOR BLACK STARTING

“Black starting” can refer to starting an electrical system from a de-energized state.

Electrical generators can have control systems that aim to maintain particular electrical parameters at the output of the generator. In a DC system, the control system commonly targets either a specified output voltage or output current, within a narrow range. In an AC system, the control system commonly targets a specified output voltage and frequency, within narrow ranges, and also commonly aims to keep the voltage and current roughly in phase with each other.

When an electrical load is connected to a power supply, the electrical load can cause the voltage and (in AC systems) frequency to drop and—depending on the nature of the electrical load—can tend to cause the current in an AC system to move out of phase with the voltage. The generator and electrical supply system can compensate for these effects.

If the electrical load is very small compared to the generator capacity, the effects are generally small even if little is done to compensate for these effects; if the electrical load is large compared to the generator capacity, the effects can be difficult to compensate fully. It can be helpful, during a black start, to have the load come online in relatively small increments relative to the capacity of the generator and, especially, relative to the range within which the generator's control system is able to maintain the output parameters within the target range. A modular system—comprising many relatively small modular loads—and a control system configured to manage the entire electrical system—can facilitate this.

The generator control system is not the only thing that helps to keep the output parameters within the target range: electrical inertia is also a factor. Where the generator's control systems are attempting to lock the generator to a bus (sometimes called a grid following design because the bus is commonly tied to an electric grid), if the bus is sufficiently resistant to changing its frequency or phase, the generator can converge on the frequency and phase of the bus and temporary errors in the generator's frequency/phase will not propagate. If the bus is being driven by a small number of similarly-sized generators, however, errors in one generator's frequency or phase can significantly alter the frequency/phase of the bus and cause the control system(s) of the other generator(s) to attempt to compensate; the resulting interaction between the control systems of the generators can become complex and unstable. This is more likely to occur if the inertia (e.g., resistance to frequency/phase change) of each generator is relatively small, enabling that generator's frequency/phase to shift quickly relative to the AC frequency. Generators that use large rotating machines (like grid-connected fossil-fueled generators) tend to contribute relatively high inertia to the bus; purely electronic generators of AC, such as inverters, tend to contribute relatively low effective inertia, and systems relying on them to form the AC with the correct frequency are consequently more prone to instability.

Inverters can be designed so that they lock their output voltage to a reference signal. These grid forming inverters can provide a solution to black start in the absence of any pre-existing bus frequency or voltage, and mitigate the instability issues that arise when multiple grid-following inverters attempt to synchronize to each other. However, their design can be challenging: implementation can be expensive and there are limits to their ability to force the bus voltage as desired. A mix of grid-forming and grid-following inverters can be desirable from a cost perspective, where the mix provides sufficient grid-forming capacity to ensure system stability in the presence of the grid-following inverters: the grid-forming inverters effectively serve as leaders, and the grid-following inverters attempt to follow the leaders.

The challenge of locking low-inertia AC sources (like inverters—especially grid-following inverters) together is exacerbated by any voltage/frequency/phase transients induced by connecting the load(s) to the generator(s). Again, modularizing the load during black start can help to mitigate these issues.

### Black Starting a Set of Modular AC Power Plants

Modular generators and modular facilities (with modular loads) provide opportunities to design black start procedures that can accommodate the inertial and stability limitations of inverter-based AC power systems.

For example, referring to FIG. 8, a black start can be initiated with all the bridges 802 set to block power transfer. Once the first modular generator is ready to deliver power, the bridge between that first modular generator and one of the modular loads can be signaled (e.g., by control system 804) to begin power flow. The modular generator can be configured to maintain voltage and AC frequency within predefined acceptable ranges when power initially begins to flow to the modular load. As the connected load becomes larger, the challenges of black starting can also become larger; by modularizing the system, each increment of load can be matched to the black start capacity of a corresponding increment of generating capacity.

In FIG. 8, the power systems (a modular generator and modular load pair) are shown as five entirely isolated systems, as long as the cross-bus bridges 802 between the systems block power flow. This, however, makes capturing the benefit of load diversity difficult: as each modular load's power demands fluctuate, the entire fluctuation is absorbed by a single modular generator. If, after bringing all the modular generators and modular loads online, the cross-bus bridges 802 enable power flow between the systems, any subsequent fluctuation in power demanded by one modular load can be shared across all the modular generators. So, during black starting, a single modular generator can be brought online and used to start a single modular load, a second modular generator can then be brought online and synchronized to the first modular generator, and then connected to the first modular generator and the first modular load using the first cross-bus bridge. Thereafter, a second modular load can be connected to the second modular generator (while leaving the first modular generator and second modular generator connected to each other). Relative to the capacity of the connected power plants, the connection of the second modular load presents a smaller challenge, in terms of maintaining voltage and frequency, than the connection of the first modular load did. This procedure can be continued until all the modular loads are powered.

An alternative procedure can involve bringing the first modular generator online with its associated modular load, thereafter starting a second modular generator and synchronizing the second modular generator to the first modular generator, thereafter starting a third modular generator and synchronizing that third modular generator with the first and/or second modular generators, and so on before beginning to connect the modular loads sequentially. In some implementations, it can be desirable to connect a minimum number of modular loads to the modular generators, depending on how many modular generators are brought online. This alternative procedure can enable the modular generators to synchronize to each other without the disruptive effects of being connected to a modular load. The effective inertia of all the modular generators could then be available to handle the disruptive effect of connecting each modular load, enabling the system to maintain stable frequency as the loads are connected in sequence.

### Black-Starting an AC System With a Specialized Grid-Forming Resource

Some implementations relate to a specialized grid-forming resource that is used by the system. The specialized grid-forming resource can be a device like a synchronous condenser (which incorporates physical inertia), a grid-forming inverter (which effectively incorporates electrical inertia), or a large capacitor (which incorporates electrical energy that can be used to rapidly deliver electrical inertia).

During the black start process, as each load is brought online in sequence, the grid-forming resource can be bridged into the corresponding power bus, providing additional (effective) inertia and stability to the bus during the startup sequence.

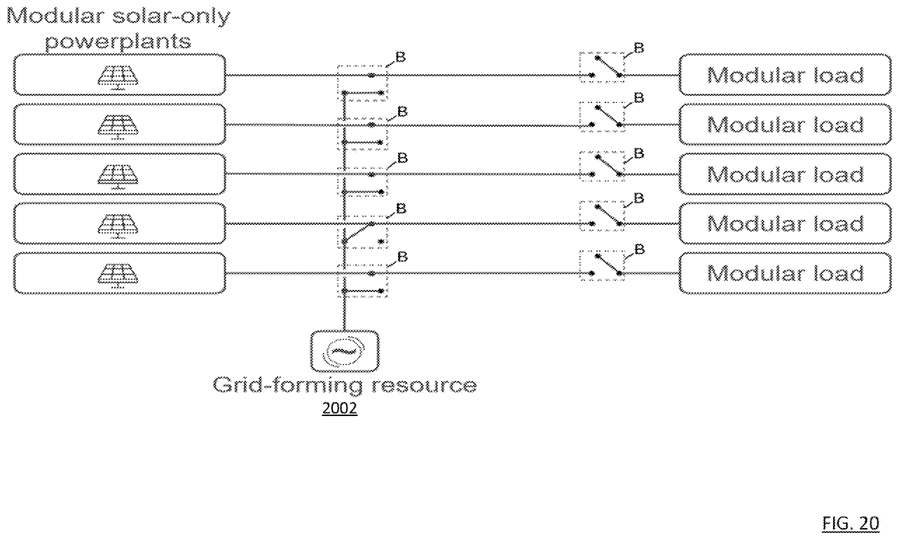

FIG. 20 illustrates an example of a grid-forming resource 2002 bridged into a system of modular generators and modular loads, so that the grid-forming resource 2002 can be connected to any one of the power buses attached to the modular loads and support the startup procedure. Although not shown in FIG. 20, a control system can be operatively coupled to any one or more devices shown in FIG. 20.

### Black Starting Where the Modular Loads Have Associated ESS

Where the modular loads have ESS associated with them—as in FIG. 19—the ESS can be used as loads during the black start procedure. If a PCS device cannot or does not function properly without having an electrical load to deliver power to, rather than a process that involves starting and synchronizing inverters before connecting the modular loads, the load-associated energy storage systems (ESS) can be used as controllable loads, drawing power at the desired or required rate to enable the generator inverters to start and synchronize.

### Black Starting Using DC Power—Stability Considerations

If the power generation system delivers DC power rather than AC power, frequency and phase do not exist but the system tries to maintain bus voltage within a narrow range. When a load is connected to the generating system, the load can pull down the voltage. DC generating systems can have a voltage regulator to maintain the bus voltage, such as a switching voltage regulator (e.g., DC/DC converter). Voltage regulators have control systems that attempt to maintain a stable bus voltage. If multiple regulators are connected to a common bus, the interaction between their control systems can lead to instability—such as when connected to a fluctuating load (the largest load fluctuation is often the one that occurs when the load is first connected to the generation). As the connected load becomes larger, the challenges of maintaining line voltage during black starting also become larger; by modularizing the system, it is possible to keep each increment of load to a size the voltage regulating capacity of the system can manage.

### Black Starting a Modular DC System

The starting of a modular DC system is qualitatively similar to the starting of a modular AC system: the generation capacity is to be connected to the load in such a way that the generation output can be kept stable. So, each modular generator can be brought online and then connected to the corresponding modular load, which can be sized to ensure that the voltage regulating capacity of the power plant is sufficient when faced with the connection of the modular load. Optionally, once the power plants and loads have been connected and the bus voltages confirmed stable, cross-bus bridges between the power plant and load systems can be directed to allow power flow so that a fluctuation in power demanded by any one load is shared across all the modular generators. Alternatively or in addition to cross-bus bridges, one or more switches or inverters acting as switches can be used.

In an alternative procedure, a single modular generator can be brought online and used to start a single modular load. A second modular generator can then be brought online, voltage-matched to the first modular generator, and then connected to the first modular generator and the first modular load using the first cross-bus bridge. Thereafter, a second modular load can be connected. Relative to the capacity of the connected power plants, the connection of the second modular load can present a smaller challenge, in terms of maintaining voltage, than the connection of the first modular load did. This procedure can be continued until all the modular loads are powered.

### ADDITIONAL ADVANTAGES OF OPERATING AS A DC SYSTEM

While the embodiments described herein can be either AC or DC electrical systems, one or more of the following advantages can be specific to DC operation.
No maintaining frequency and phase of the AC power within narrow ranges.
No synchronizing AC power systems.
No suppressing harmonics of (low-frequency) AC power frequency; switching frequencies in DC PCS devices can be in the kHz range, where filtration is easier.
No low-frequency transformers, which tend to be heavy, bulky and expensive; DC PCS devices tend to use internal frequencies in the kHz range, where transformers can be small, light, low-cost and efficient.
AC “hum” noise is eliminated.
Fewer degrees of freedom to be controlled; reduced risk of power system instabilities.

### CONTROLS FOR SWARM GENERATOR AND MODULAR SYSTEM

The operating approaches described herein for a swarm generator connected to a modular system of loads can be implemented using one or more controls. Depending on the implementation, controls (or a “control system”) can comprise machine-readable instructions, one or more memories capable of storing the instructions, one or more processors capable of executing the instructions, input devices capable of supplying input data and information about user interventions to the processor(s), and/or output devices capable of communicating signals to equipment being controlled and messages to users/facility operators.

In some implementations, the processor of the control system can be a hardware-based integrated circuit (IC) or any other suitable processing device configured to run and/or execute a set of instructions or code. In some implementations, the processor is a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor can operatively coupled to and in communication with other hardware in the control system, for example, through a system bus (e.g., address bus, data bus, control bus, etc.) and/or a wireless connection.

In some implementations, the memory of the control system can be a random-access memory (RAM), a memory buffer, a hard drive (e.g., solid state drive (SSD), hard disk drive (HDD), etc.), a read-only memory (ROM), an erasable programmable read-only memory (EPROM), and/or the like. In some instances, the memory can store, for example, one or more software programs and/or code that can include instructions to cause the processor to perform one or more processes, functions, and/or the like. In some implementations, the memory includes extendable storage units that can be added and used incrementally. In some implementations, the memory can be a portable memory (e.g., a flash drive, a portable hard disk, and/or the like) that can be operatively coupled to the processor.

What follows is a high-level description of controls relating to embodiments associated with the Figures herein.

### Controls for FIG. 8: Pairwise Matching With Cross-Ties

FIG. 8 shows pairwise connection through bridge connections 802 of modular generators to modular loads, configured to transfer power between buses using cross-tie connections. An example use case for such a configuration can involve starting each modular generator, then connecting that modular generator to its associated modular load and, when the system is stable and (in the case of AC) synchronized, causing the cross-tie bridges 802 to allow power to flow freely between the buses so that generator power is pooled and made available to all the loads as needed or used.

For this, and in accordance with some embodiments, the control system 804 can be configured to (where a sub-bullet of a bullet represents a sub-step of the bullet):
direct each modular generator to start (which the control system 804 can do sequentially or in parallel);
monitor the performance parameters of the modular generator(s) to determine when all the criteria for a successful startup have been completed;
if, after a predetermined time,
   the criteria for a successful startup have not been completed:
      direct the modular generator to shut down; and
      send an error message to the facility operator;
   the criteria for a successful startup have been completed:
      send an electronic signal that causes the bridge 802 to connect the modular generator to its modular load;
      monitor any parameters (such as voltage and, for an AC system, frequency) to ensure that connection to the modular load has not excessively disrupted (e.g., beyond a predefined acceptable range) the output of the modular generator;
      if, after a predetermined time,
         excessive disruption has occurred,
         send a signal to the bridge 802 to prevent power flow from the modular generator to the modular load, and
         send an error message to the facility operator;
         otherwise,
         send a message to the facility operator signaling that startup is complete;
         obtain performance parameters of each of the modular buses (e.g., voltage, and for an AC system, frequency and phase);
         after a predetermined time, determine which of the modular buses has parameters within an acceptable range; and
         where any modular bus has parameters that fall outside an acceptable range:
         send an error message to the facility operator
         otherwise:
         where any pair of adjacent power buses have parameters within the acceptable range,
         send a signal to the bridge to enable power to flow freely between them,
         otherwise
         send an error message to the facility operator,
         and then continue to the next activity.

### Controls for FIG. 9: Balancing Bus

FIG. 9 shows an example of a connecting matrix that uses a balancing bus 904. In one embodiment, the bridges 902 can be PCS devices capable of controlling both the direction and quantity of power flowing through each bridge from bridges 902. To illustrate the embodiment, consider a starting point where each modular generator is delivering the same amount of power, each modular load is receiving the same amount of power, and the power is being delivered via the modular buses that connect the modular generators and modular loads in pairwise fashion. In this illustration (where a sub-bullet of a bullet represents a sub-step of the bullet):
The control system 906 can determine that the ESS associated with each modular generator is at the same state of charge except for the ESS associated with the first modular generator, which the control system 906 can determine is at a lower state of charge.
The control system 906 can then compute an amount of energy that, drawn from each ESS except the first modular generator, and collectively added to the first modular generator will—after allowing for energy losses in the system including the ESS themselves—equalize the states of charge of all the ESS.
The control system 906 can further determine a period of time to be used to make the energy transfer and compute a first corresponding power flow that would accomplish the energy transfer from each ESS (except the first modular generator) and a second corresponding power flow that would accomplish the energy transfer to the first ESS, optionally subject to one or more of the following conditions:
   the power flow out of each modular generator (except the first modular generator) does not exceed any power limit of that generator when the first corresponding power flow is drawn from it in addition to the power flowing to the corresponding modular load;
   the power flow from the first modular generator does not exceed any power limit of that generator when its total output power is reduced below the power flowing to its corresponding modular load by an amount equal to the second corresponding power flow;
   drawing the computed amount of energy from each ESS (except the first modular generator) will not result in any ESS falling below its minimum allowed state of charge; and
   adding the computed amount of energy to the first ESS will not result in the first ESS going above its maximum allowed state of charge.
The control system 906 can:
   direct the bridge 902 connecting each modular busbar (where busbar is the electrical bus within each modular generator-modular load pair) (except the first modular busbar) to a selected balancing bus from balancing bus 904, to draw power at the first corresponding power flow rate from the modular bus bar and deliver the power to the selected balancing bus bar, and
   direct the bridge 902 connecting the first modular busbar to the selected balancing busbar to draw power at the second corresponding power flow rate from the balancing bus bar and deliver the power to the first modular busbar.

Extensions of this description to situations where the low-state-of-charge ESS is one other than the first modular busbar are contemplated. Extensions to situations where each ESS is at a different state of charge to the others are also contemplated: the amount of energy to be drawn from each ESS, or delivered to each ESS, can be different and the control signals to the bridges can be adjusted accordingly. Extensions to situations where the power flowing from each modular generator to each modular load is different are also contemplated, and can involve the control system 906 taking those differences into account when testing for power limits.

A similar controls approach can be used to equalize the power drawn from each modular generator when the power demanded or used by each modular load may be different. To illustrate such an embodiment, the control system 906 can (where a sub-bullet of a bullet represents a sub-step of the bullet):
determine the power initially output by each modular generator,
compute the average power initially output by each modular generator,
for each modular generator, determine an associated power adjustment that would cause its power output to be substantially equal to the computed average output,
confirm that adjusting the power output of each modular generator to the computed average power output would not exceed, or is unlikely to exceed, a power limit of any modular generator, and/or
send signals to the PCS devices connecting each modular busbar to a selected balancing bus, such that:
   if the corresponding power adjustment is an increase, the PCS will draw power in that amount from the modular bus bar and deliver it to the selected balancing bus; and
   if the corresponding power adjustment is a decrease, the PCS will draw power in that amount from the selected balancing bus and deliver it to the modular bus bar.

### Controls for FIG. 12: Full Crossbar Connection

FIG. 12 shows a system of bridges (B) in a full crossbar configuration that allows connection of any modular generator to any modular load(s). In some such implementations, when the control system 1204 determines that criteria for connecting a particular modular generator to a particular modular load have been satisfied, the control system 1204 sends a signal to the bridges to cause the modular generator's output to be connected to the appropriate modular load.

The controls for this architecture can be implemented at multiple levels of sophistication and using a variety of software architectures. An example embodiment can involve a DC electrical system in which the bridge, at each node of the crossbar, comprises an electrically controlled switch (such as a relay or an electronic switch), a voltage meter across the switch, and a current meter in series with the switch (where a sub-bullet of a bullet represents a sub-step of the bullet):
Initially only those switches that connect a modular generator to its associated modular load allow power flow; the others block power flow by being in the “open” position.
At each node, if the voltage meter senses a voltage difference across the switch that is above a predefined threshold value for a period longer than a predefined threshold length of time, then the control system 1204 can:
   send a signal to close the electrically controlled switch, enabling power to flow through the node; and/or
   monitor the power flow using the current meter and,
      if the current meter reading falls below a second predefined threshold value for a period longer than a second predefined threshold length of time,
         send a second signal to open the electrically controlled switch, stopping power from flowing through the node, thus returning the bridge to its initial condition.

The foregoing embodiment can enable the array of modular generators to serve the varying, and not necessarily matched, power demands of the array of modular loads while balancing the power demand across the array of modular generators; the foregoing embodiment can also automatically (e.g., without human intervention) adjust for any failure of a modular generator.

For a DC or AC electrical system, in some implementations, the control system 1204 can one or more of:
continually, periodically, repeatedly, or sporadically receive data relating to the power generating capacity and current power output of each modular generator;
continually, periodically, repeatedly, or sporadically receive a forecast of the power generating capacity of each modular generator for one or more time windows within a first forecast period;
continually, periodically, repeatedly, or sporadically receive a forecast of the power demanded by each modular load for one or more time windows within a forecast period, which may be a second forecast period;
determine or receive an opportunity metric for each modular load, for one or more time windows within a forecast period, which may be a third forecast period;
using a model configured to improve (e.g., maximize) a performance score (e.g., the model configured to perform a maximum-finding algorithm), iteratively, until a set of control signals is found that maximizes (or approximately maximizes) the performance score:
   define, for a number (which can be one) of time periods within a simulation time window, sets of control signals to the connecting matrix,
      simulate the operation of the powerplant across the forecast period (or, if applicable, the shortest of the forecast periods) subject to operating constraints that can include, but are not limited to, one or more of:
         the output power of each modular generator, at any time within the simulation period, is not greater than the lesser of a) the forecast power generating capacity of the modular generator for that time or b) any applicable electrical engineering power limit of the modular generator;
         the power delivered to each modular load, at any time within the simulation period, is not greater than the lesser of a) the forecast power demanded by that modular load or b) any applicable electrical engineering power limit of the modular load; or
         the total power delivered by all the modular generators, taken together, is not less than the sum of the total power delivered to all the modular loads plus the calculated electrical power losses due to transmission of power through the system from the modular generators to the modular loads;
      compute a performance score for the period based on at least:
         power delivered to each modular load from time to time within the simulation forecast period, e.g., weighted by the opportunity metric for that load at the corresponding times; and/or
         change in energy stored in any energy storage devices connected to the system, which can be weighted by an opportunity metric determined at the start and end of the simulation period;
      adjust the sequence of simulated control signals and re-simulate the operation, computing a new performance score;
send a set of control signals to the connecting matrix 1202 that corresponds to the initial control signals of the performance-score maximizing set, then
update the control signals to the connecting matrix 1202 in accordance with the sequence of control signals in the performance-score maximizing set until either
   there is a deviation greater than a threshold value for either of:
      the energy stored in any energy storage devices in the system; or
      data relating to the power generating capacity or current power output of any modular generator or,
   the control system 1204 receives:
      a new forecast of the power generating capacity of each modular generator; or
      a new forecast of the power demanded by each modular load; or
      determines or receives a new set of opportunity metrics for the modular loads,
at which time the control system 1204 can begin a new sequence of simulations to discover a new set of performance-score maximizing control signals.

Another embodiment can use machine learning to enable faster discovery of performance-score maximizing control signals, so that the optimization process can be conducted more rapidly and more frequently, enabling a machine learning model(s) (e.g., stored at control system 1204) to incorporate new information more quickly and more often.

### Controls for FIG. 13: Partial Crossbar Connection

FIG. 13 shows a system of bridges in a partial crossbar configuration, in accordance with an embodiment. Controls for this configuration could be substantially the same as those for the full crossbar configuration (FIG. 12), but with modifications to the simulation and controls to allow for the fact that not all the bridges that would be present in the full crossbar configuration would be present in the partial crossbar configuration.

### Controls for FIG. 14: Connecting a Centralized Power Supply, in Addition to the Swarm Generator, to the Modular Loads

The bridges (B) in FIG. 14 allow connection of the centralized power source 1402 to any modular load. If the bridges are implemented as electrically controlled switches, the modular load can be switched between a) the centralized power source 1402 and b) power derived from a connecting matrix drawing power from the modular generators. In some implementations, the modular load can draw power from both the centralized power source 1402 and the system of modular generators at the same time.

The foregoing additional functionality can be described as follows. The control system (where a sub-bullet of a bullet represents a sub-step of the bullet):
continually, periodically, repeatedly, or sporadically determines if criteria for connecting the centralized power source 1402 to a particular modular generator have been satisfied. If so,
   the control system sends a signal to the corresponding bridge, enabling power to flow from the centralized power source 1402 to the modular load.

More generally, a connecting matrix can be used so that power from the centralized power source 1402 is treated as another generator (albeit possibly larger than a modular generator) and bridges can enable power to flow from the centralized power source 1402 to the modular loads through the connecting matrix. The controls for the connecting matrix can then be any of the controls described herein.

### Controls for FIG. 15: Connecting a Centralized Power Supply to the Modular Generators

FIG. 15 shows an example of a centralized power source 1502 that can be connected through bridges to any of the modular generators, thereby enabling each modular generator so connected to commingle and manage power from both the centralized power source 1502 and the renewable source (and ESS, where the modular generator is so equipped).

When the control system determines that criteria for connecting the centralized power source 1502 to a particular modular generator have been satisfied, the control system sends control signals to the additional bridging system, enabling power from the centralized power source 1502 to be supplied, as appropriate, to the modular generators.

### Controls for FIG. 18: Connecting a Centralized ESS

The additional element in FIG. 18, relative to some preceding Figures herein, is the presence of a central energy storage system (ESS) 1804. Control of the central ESS 1804 (e.g., connected to one or more generators and/or loads) can be implemented, for example, in domestic solar & storage installations.

The presence of ESS(es) associated with each modular generator, and a central ESS 1804, can enable the use of lower-power circuitry and thus a more efficient use of resources. Consider, first, a system with only a central ESS, but no ESS(es) associated with each modular generator. If the generators are from renewable energy such as solar, then for the central ESS to store energy produced by each generator at peak production times, the electrical equipment (wiring, switches, etc., constituting each bus) between the generators and the central ESS can be large enough/otherwise configured to carry power at peak production rates. Now, if ESS(es) are added to the system at each generator, then those ESS(es) can be used to store energy that is produced during times of peak power generation and only the amounts demanded by the loads need be transmitted through the buses, allowing the design to use lower-power equipment in the buses. In some such implementations, the ESS(es) associated with each generator have capacity to receive energy during those peak hours, and can be discharged during low-generation hours by sending the energy to the load and/or to a central ESS(es) during those hours.

In addition, if the loads demand variable amounts of power, including demanding peak power for relatively limited periods, then the buses up to the central ESS can be sized for power at below-peak levels. The buses from the central ESS to the loads can be sized for peak levels. Then, during peak power demand, the central ESS can augment the (limited) power from the generator.

### Controls for FIG. 20: Connecting a Grid-Forming Resource

The grid-forming resource 2002 can be used when bringing modular generators and/or modular loads online, including when “black starting” the system. The controls for this configuration are therefore substantially the same as those described for FIG. 9, except that the modular generators are started and connected to their modular loads sequentially (whereas the description for FIG. 9 allows them to be started and connected in parallel); and during each startup and connection procedure, the control system sends signals to the bridging system that result in the grid-forming resource 2002 being connected to the associated power bus to provide grid-forming support to that bus during the starting process.

The grid-forming resource 2002 can be used when bringing modular generators and/or modular loads online, including when “black starting” the system. The controls for this configuration are therefore substantially the same as those described for FIG. 9, except that the modular generators are started and connected to their modular loads sequentially (whereas the description for FIG. 9 allows them to be started and connected in parallel); and during each startup and connection procedure, the control system sends signals to the bridging system that result in the grid-forming resource 2002 being connected to the associated power bus to provide grid-forming support to that bus during the starting process.

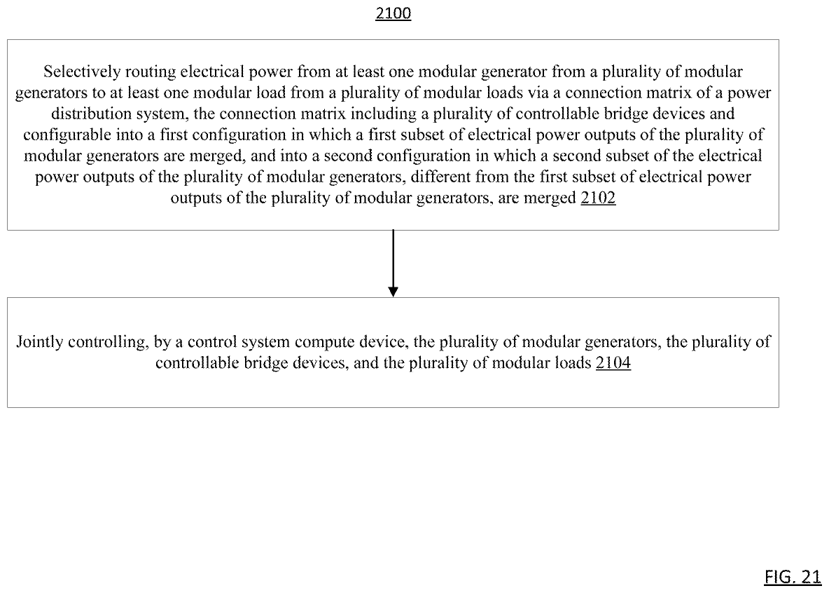

FIG. 21 illustrates a flowchart of a method 2100 to selectively route electrical power, according to an embodiment. In some implementations, one or more steps of method 2100 can be performed by a processor of a control system.

At 2102, electrical power is selectively routed from at least one modular generator from a plurality of modular generators to at least one modular load from a plurality of modular loads via a connection matrix (e.g., connecting matrix 404, 1202, 1504) of a power distribution system. The connection matrix includes a plurality of controllable bridge devices (e.g., “B”). The connection matrix is configurable into a first configuration in which at least a subset of electrical power outputs of the plurality of modular generators are merged, and into a second configuration in which none of the electrical power outputs of the plurality of modular generators are merged.

At 2104, a control system compute device (e.g., control system 406, 804, 906, 1204, and/or the like) jointly controls (e.g., applying control inputs to multiple controlled devices, in a coordinated fashion, to improve (e.g., maximize or minimize) a metric) the plurality of modular generators, the plurality of controllable bridge devices, and the plurality of modular loads.

Some implementations of method 2100 further include assigning a priority level to each modular load from the plurality of modular loads. Some implementations of method 2100 further include, in response to detecting a shortfall in available power from the plurality of modular generators, causing (e.g., by sending an electronic signal with instructions to) disconnection of at least one lower-priority modular load from the plurality of modular loads until a total remaining load has a value that can be serviced by the available power from the plurality of modular generators.

Some implementations of method 2100 further include performing a black start procedure by causing (e.g., by sending an electronic signal with instructions to) a first modular generator from the plurality of modular generators to start, connecting the first modular generator to a first modular load from the plurality of modular loads via a first controllable bridge device of the connection matrix, monitoring electrical parameters of the first modular generator after connection to the first modular load, and after confirming stable electrical parameters, connecting at least a second modular generator from the plurality of modular generators and at least a second modular load from the plurality of modular loads to the power distribution system.

In some implementations of method 2100, each controllable bridge device from the plurality of controllable bridge devices comprises a power conversion system (PCS) device configured to control a magnitude and a direction of power flow through that controllable bridge device.

Some implementations of method 2100 further include detecting a fault associated with one of the plurality of modular generators or one of the plurality of controllable bridge devices, and causing a reconfiguration of the connection matrix, via the control system compute device, to route power around the detected fault by adjusting at least one control signal to at least one controllable bridge device from the plurality of controllable bridge devices.

Some implementations of method 2100 further include receiving, at the control system compute device, a forecast of power generating capacity for each modular generator from the plurality of modular generators over a forecast period. Some implementations of method 2100 further include iteratively simulating operation of the power distribution system across the forecast period to identify a set of control signals to the connection matrix that maximizes a performance score. Some implementations of method 2100 further include causing transmission of the identified set of control signals to the connection matrix.

In some implementations of method 2100, the electrical power is selectively routed through a balancing bus (e.g., balancing bus 904, 1004, 1102A, 1102B, and/or the like) of the connection matrix. Some implementations of method 2100 further include controlling a direction and a magnitude of power flow through each controllable bridge device from the plurality of controllable bridge devices and coupled to the balancing bus such that power is transferred from a modular generator from the plurality of modular generators having excess capacity to a modular load from the plurality of modular loads that is experiencing a power deficit.

Some implementations of method 2100 further include connecting a centralized energy storage system (ESS) (e.g., central ESS 1602, 1804, and/or the like) to the connection matrix via one or more controllable bridge devices (e.g., from the plurality of controllable bridge devices). Some implementations of method 2100 further include jointly controlling the centralized ESS with the plurality of modular generators, the plurality of controllable bridge devices, and the plurality of modular loads, by selectively (1) charging, at a first time, the centralized ESS from at least one modular generator from the plurality of modular generators, and (2) discharging, at a second time different from the first time, the centralized ESS to at least one modular load from the plurality of modular loads.

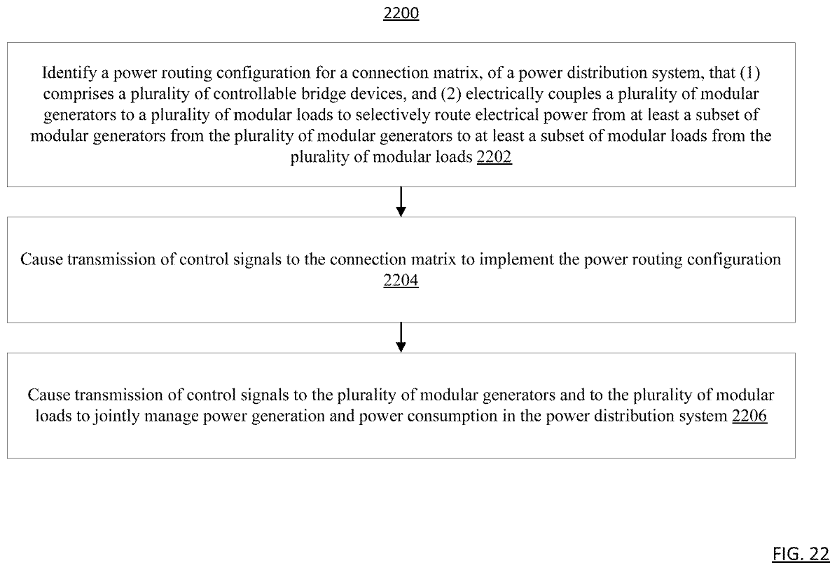

FIG. 22 illustrates a flowchart of a method 2200 to jointly manage power generation and power consumption in a power distribution system, according to an embodiment. In some implementations, one or more steps of method 2200 can be performed by a processor of a control system.

At 2202, a power routing configuration for a connection matrix (e.g., connecting matrix 404, 1202, 1504, and/or the like), of a power distribution system, is identified that (1) comprises a plurality of controllable bridge devices, and (2) electrically couples a plurality of modular generators to a plurality of modular loads to selectively route electrical power from at least a subset of modular generators from the plurality of modular generators to at least a subset of modular loads from the plurality of modular loads.

At 2204, control signals are caused to be transmitted to the connection matrix to implement the power routing configuration. For example, the control system can send an electronic signal with instructions to implement the power routing configuration to the connection matrix.

At 2206, control signals are caused to be transmitted to the plurality of modular generators and to the plurality of modular loads to jointly manage power generation and power consumption in the power distribution system.

Some implementations of method 2200 further include assigning priority levels to the plurality of modular loads. Some implementations of method 2200 further include, in response to a detected shortfall in available power, causing transmission of a control signal to disconnect at least one modular load from the plurality of modular loads having a lower associated priority level.

Some implementations of method 2200 further include receiving a forecast of power generating capacity for each modular generator from the plurality of modular generators and a forecast of power demand for each modular load from the plurality of modular loads over a forecast period. Some implementations of method 2200 further include iteratively simulating operation of the power distribution system over the forecast period using a maximum-finding algorithm to identify a set of control signals that maximizes a performance score. Some implementations of method 2200 further include causing transmission of the identified set of control signals to the connection matrix. In some implementations, the performance score is based on at least one of: a power delivered to each modular load from the plurality of modular loads weighted by an opportunity metric, or a change in energy stored in at least one energy storage system connected to the power distribution system.

In some implementations of method 2200, the power routing configuration is a first power routing configuration. Some implementations of method 2200 further include detecting a fault condition associated with at least one of the plurality of modular generators or the plurality of controllable bridge devices. Some implementations of method 2200 further include, in response to detecting the fault condition, causing transmission of updated control signals to the connection matrix to implement a second power routing configuration different from the first power routing configuration.

In some implementations of method 2200, causing transmission of control signals to the plurality of modular generators and to the plurality of modular loads at 2206 includes causing transmission of a first control signal to the plurality of modular loads, to cause a power demand reduction at the plurality of modular loads during a first time period during which an energy storage system (ESS) is to supply power to the plurality of modular loads, and causing transmission of a second control signal to the plurality of modular loads, to cause a power demand increase at the plurality of modular loads during a second time period during which the plurality of modular generators is to supply power to the plurality of modular loads.

Some implementations relate to a system. The system includes a plurality of modular generators. Each modular generator from the plurality of modular generators is configured to produce electrical power. The system further includes a plurality of modular loads. Each modular load from the plurality of modular loads is configured to consume electrical power. The system further includes a connection matrix (e.g., connecting matrix 404, 1202, 1504, and/or the like) including a plurality of controllable bridge devices (“B”) and configured to selectively route electrical power from any one or more modular generators from the plurality of modular generators to any one or more modular loads from the plurality of modular loads. The connection matrix is configurable into a first configuration in which a first subset of electrical power outputs of the plurality of modular generators are merged, and into a second configuration in which a second subset of the electrical power outputs of the plurality of modular generators, different from the first subset of electrical power outputs of the plurality of modular generators, are merged. The connection matrix defines, at least in part, a power distribution system. The system further includes a control system configured to control each of the plurality of modular generators, the plurality of controllable bridge devices of the connection matrix, and the plurality of modular loads.

In some implementations of the system, at least one controllable bridge device from the plurality of controllable bridge devices comprises a galvanically isolated dual-active bridge (DAB) DC/DC converter configured to control a direction and quantity of power flowing therethrough.

In some implementations of the system, each modular generator from the plurality of modular generators comprises a plurality of solar photovoltaic (PV) strings, a DC/DC converter configured to receive DC power from the plurality of solar PV strings and to output DC power at a substantially constant output voltage, and an energy storage system (ESS) coupled to the DC/DC converter. In some implementations, the control system is further configured to balance states of charge among the energy storage systems associated with the plurality of modular generators by directing power flows through the connection matrix.

In some implementations of the system, the connection matrix is arranged in one of: a pairwise configuration in which each modular generator from the plurality of modular generators is paired with an associated modular load from the plurality of modular loads, the plurality of controllable bridge devices including cross-tie bridges that selectively transfer power between adjacent generator-load pairs; a single balancing bus configuration in which each modular generator from the plurality of modular generators and each modular load from the plurality of modular loads is connected to a common balancing bus via an associated controllable bridge device; a multiple balancing bus configuration including a first balancing bus and at least a second balancing bus, wherein each modular generator from the plurality of modular generators and each modular load from the plurality of modular loads is connected to both the first balancing bus and the second balancing bus via respective controllable bridge devices; a full crossbar configuration in which any modular generator from the plurality of modular generators is connectable, via an associated controllable bridge device from the plurality of controllable bridge devices, to any modular load from the plurality of modular loads; or a partial crossbar configuration in which each modular load from the plurality of modular loads is connectable to a subset of modular generators from the plurality of modular generators.

In some implementations of the system, the control system is further configured to receive a forecast of power generating capacity for each modular generator from the plurality of modular generators over a forecast period, receive a forecast of power demand for each modular load from the plurality of modular loads over the forecast period, iteratively simulate operation of the power distribution system across the forecast period to identify a set of control signals that maximizes a performance score based on at least one of a power delivered to each modular load from the plurality of modular loads or a change in energy stored in one or more energy storage systems connected to the power distribution system, and cause transmission of the identified set of control signals to the connection matrix.

As used in this specification and the appended claims, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and/or “approximately” when used in conjunction with numerical values and/or ranges generally refer to those numerical values and/or ranges near to a recited numerical value and/or range. For example, in some instances, “about 40 [units]” can mean within ±25% of 40 (e.g., from 30 to 50). In some instances, the terms “about” and “approximately” can mean within ±10% of the recited value. In other instances, the terms “about” and “approximately” can mean within ±9%, ±8%, ±7%, ±6%, ±5%, ±4%, ±3%, ±2%, ±1%, less than ±1%, or any other value or range of values therein or therebelow. The terms “about” and “approximately” may be used interchangeably. Furthermore, although a numerical value modified by the term “about” or “approximately” can allow for and/or otherwise encompass a tolerance of the stated numerical value, it is not intended to exclude the exact numerical value stated.

In a similar manner, term “substantially” when used in connection with, for example, a geometric relationship, a numerical value, and/or a range is intended to convey that the geometric relationship (or the structures described thereby), the number, and/or the range so defined is nominally the recited geometric relationship, number, and/or range. For example, two structures described herein as being “substantially non-parallel” is intended to convey that, although a non-parallel geometric relationship is desirable, some parallelism can occur in a “substantially non-parallel” arrangement. Such tolerances can result from manufacturing tolerances, measurement tolerances, and/or other practical considerations (such as, for example, minute imperfections, age of a structure so defined, a pressure or a force exerted within a system, and/or the like). As described above, a suitable tolerance can be, for example, of ±1%, ±2%, ±3%, ±4%, ±5%, ±6%, ±7%, ±8%, ±9%, ±10%, or more of the stated geometric construction, numerical value, and/or range. Furthermore, although a numerical value modified by the term “substantially” can allow for and/or otherwise encompass a tolerance of the stated numerical value, it is not intended to exclude the exact numerical value stated.

The specific configurations of the various components described herein can also be varied. For example, the size and specific shape of the various components can be different from the embodiments shown, while still providing the functions as described herein. Additionally, the relative size of various components of the devices shown and described herein with respect to the size of other components of the devices are not necessarily to scale.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Similarly, where methods and/or events described above indicate certain events and/or procedures occurring in certain order, the ordering of certain events and/or procedures may be modified. While the embodiments have been particularly shown and described, it will be understood that various changes in form and details may be made. Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system, comprising:
a plurality of modular generators, each modular generator from the plurality of modular generators configured to produce electrical power;
a plurality of modular loads, each modular load from the plurality of modular loads configured to consume electrical power;
a connection matrix including a plurality of controllable bridge devices and configurable to selectively route electrical power from any one or more modular generators from the plurality of modular generators to any one or more modular loads from the plurality of modular loads, the connection matrix defining, at least in part, a power distribution system; and
a control system configured to control each of the plurality of modular generators, the plurality of controllable bridge devices of the connection matrix, and the plurality of modular loads.

2. The system of claim 1, wherein at least one controllable bridge device from the plurality of controllable bridge devices comprises a galvanically isolated dual-active bridge (DAB) DC/DC converter configured to control a direction and quantity of power flowing therethrough.

3. The system of claim 1, wherein each modular generator from the plurality of modular generators comprises:
a plurality of solar photovoltaic (PV) strings;
a DC/DC converter configured to receive DC power from the plurality of solar PV strings and to output DC power at a substantially constant output voltage; and
an energy storage system (ESS) coupled to the DC/DC converter.

4. The system of claim 3, wherein the control system is further configured to balance states of charge among the energy storage systems associated with the plurality of modular generators by directing power flows through the connection matrix.

5. The system of claim 1, wherein the connection matrix is arranged in one of:
a pairwise configuration in which each modular generator from the plurality of modular generators is paired with an associated modular load from the plurality of modular loads, the plurality of controllable bridge devices including cross-tie bridges that selectively transfer power between adjacent generator-load pairs;
a single balancing bus configuration in which each modular generator from the plurality of modular generators and each modular load from the plurality of modular loads is connected to a common balancing bus via an associated controllable bridge device;
a multiple balancing bus configuration including a first balancing bus and at least a second balancing bus, wherein each modular generator from the plurality of modular generators and each modular load from the plurality of modular loads is connected to both the first balancing bus and the second balancing bus via respective controllable bridge devices;
a full crossbar configuration in which any modular generator from the plurality of modular generators is connectable, via an associated controllable bridge device from the plurality of controllable bridge devices, to any modular load from the plurality of modular loads; or
a partial crossbar configuration in which each modular load from the plurality of modular loads is connectable to a subset of modular generators from the plurality of modular generators.

6. The system of claim 1, wherein the control system is further configured to:
receive a forecast of power generating capacity for each modular generator from the plurality of modular generators over a forecast period;
receive a forecast of power demand for each modular load from the plurality of modular loads over the forecast period;
iteratively simulate operation of the power distribution system across the forecast period to identify a set of control signals that maximizes a performance score based on at least one of a power delivered to each modular load from the plurality of modular loads or a change in energy stored in one or more energy storage systems connected to the power distribution system; and
cause transmission of the identified set of control signals to the connection matrix.

7. A method, comprising:
selectively routing electrical power from at least one modular generator from a plurality of modular generators to at least one modular load from a plurality of modular loads via a connection matrix of a power distribution system, the connection matrix including a plurality of controllable bridge devices and configurable into a first configuration in which a first subset of electrical power outputs of the plurality of modular generators are merged, and into a second configuration in which a second subset of the electrical power outputs of the plurality of modular generators, different from the first subset of electrical power outputs of the plurality of modular generators, are merged; and
jointly controlling, by a control system compute device, the plurality of modular generators, the plurality of controllable bridge devices, and the plurality of modular loads.

8. The method of claim 7, further comprising:
assigning a priority level to each modular load from the plurality of modular loads; and
in response to detecting a shortfall in available power from the plurality of modular generators, causing disconnection of at least one lower-priority modular load from the plurality of modular loads until a total remaining load has a value that can be serviced by the available power from the plurality of modular generators.

9. The method of claim 7, further comprising performing a black start procedure by:
causing a first modular generator from the plurality of modular generators to start;
connecting the first modular generator to a first modular load from the plurality of modular loads via a first controllable bridge device of the connection matrix;
monitoring electrical parameters of the first modular generator after connection to the first modular load; and
after confirming stable electrical parameters, connecting at least a second modular generator from the plurality of modular generators and at least a second modular load from the plurality of modular loads to the power distribution system.

10. The method of claim 7, wherein each controllable bridge device from the plurality of controllable bridge devices comprises a power conversion system (PCS) device configured to control a magnitude and a direction of power flow through that controllable bridge device.

11. The method of claim 7, further comprising:
detecting a fault associated with one of the plurality of modular generators or one of the plurality of controllable bridge devices; and
causing a reconfiguration of the connection matrix, via the control system compute device, to route power around the detected fault by adjusting at least one control signal to at least one controllable bridge device from the plurality of controllable bridge devices.

12. The method of claim 7, further comprising:
receiving, at the control system compute device, a forecast of power generating capacity for each modular generator from the plurality of modular generators over a forecast period;
iteratively simulating operation of the power distribution system across the forecast period to identify a set of control signals to the connection matrix that maximizes a performance score; and
causing transmission of the identified set of control signals to the connection matrix.

13. The method of claim 7, wherein the electrical power is selectively routed through a balancing bus of the connection matrix, the method further including controlling a direction and a magnitude of power flow through each controllable bridge device from the plurality of controllable bridge devices and coupled to the balancing bus such that power is transferred from a modular generator from the plurality of modular generators having excess capacity to a modular load from the plurality of modular loads that is experiencing a power deficit.

14. The method of claim 7, further comprising:
connecting a centralized energy storage system (ESS) to the connection matrix via one or more controllable bridge devices; and
jointly controlling the centralized ESS with the plurality of modular generators, the plurality of controllable bridge devices, and the plurality of modular loads, by selectively (1) charging, at a first time, the centralized ESS from at least one modular generator from the plurality of modular generators, and (2) discharging, at a second time different from the first time, the centralized ESS to at least one modular load from the plurality of modular loads.

15. A non-transitory computer-readable medium storing instructions that, when executed by a processor, cause the processor to:
identify a power routing configuration for a connection matrix, of a power distribution system, that (1) comprises a plurality of controllable bridge devices, and (2) electrically couples a plurality of modular generators to a plurality of modular loads to selectively route electrical power from at least a subset of modular generators from the plurality of modular generators to at least a subset of modular loads from the plurality of modular loads;
cause transmission of control signals to the connection matrix to implement the power routing configuration; and
cause transmission of control signals to the plurality of modular generators and to the plurality of modular loads to jointly manage power generation and power consumption in the power distribution system.

16. The non-transitory computer-readable medium of claim 15, wherein the instructions, when executed by the processor, further cause the processor to:
assign priority levels to the plurality of modular loads; and
in response to a detected shortfall in available power, cause transmission of a control signal to disconnect at least one modular load from the plurality of modular loads having a lower associated priority level.

17. The non-transitory computer-readable medium of claim 15, wherein the instructions, when executed by the processor, further cause the processor to:
receive a forecast of power generating capacity for each modular generator from the plurality of modular generators and a forecast of power demand for each modular load from the plurality of modular loads over a forecast period;
iteratively simulate operation of the power distribution system over the forecast period using a maximum-finding algorithm to identify a set of control signals that maximizes a performance score; and
cause transmission of the identified set of control signals to the connection matrix.

18. The non-transitory computer-readable medium of claim 17, wherein the performance score is based on at least one of: a power delivered to each modular load from the plurality of modular loads weighted by an opportunity metric, or a change in energy stored in at least one energy storage system connected to the power distribution system.

19. The non-transitory computer-readable medium of claim 15, wherein the power routing configuration is a first power routing configuration, and the instructions, when executed by the processor, further cause the processor to:
detect a fault condition associated with at least one of the plurality of modular generators or the plurality of controllable bridge devices; and
in response to detecting the fault condition, cause transmission of updated control signals to the connection matrix to implement a second power routing configuration different from the first power routing configuration.

20. The non-transitory computer-readable medium of claim 15, wherein the instructions to cause transmission of control signals to the plurality of modular generators and to the plurality of modular loads include instructions to:
cause transmission of a first control signal to the plurality of modular loads, to cause a power demand reduction at the plurality of modular loads during a first time period during which an energy storage system (ESS) and not the plurality of modular generators is to supply power to the plurality of modular loads; and
cause transmission of a second control signal to the plurality of modular loads, to cause a power demand increase at the plurality of modular loads during a second time period during which at least the plurality of modular generators is to supply power to the plurality of modular loads.
